(19) United States
(12) Patent Application Publication
(10) Pub. No.: US 2021/0406896 A1
(43) Pub. Date: Dec. 30, 2021

(54) TRANSACTION PERIODICITY FORECAST USING MACHINE LEARNING-TRAINED CLASSIFIER

(71) Applicant: PayPal, Inc., San Jose, CA (US)

(72) Inventor: Anubhav Chaturvedi, San Jose, CA (US)

(21) Appl. No.: 16/915,790

(22) Filed: Jun. 29, 2020

(51) Int. Cl. G06Q 20/40; G06K 9/66; G06K 9/62; G06Q 20/20

(52) U.S. Cl. CPC G06Q 20/4016; G06Q 20/209; G06K 9/6217; G06K 9/66

(57) ABSTRACT

Transaction periodicity forecasting using a machine learning-trained classifier for increasing a transaction success rate is disclosed. A transaction processing server may receive, through an application programming interface from a remote server, a first transaction request to process a transaction in an interaction between the remote server and a user device. The server may classify the transaction as a recurrent transaction with a machine learning-trained classifier based on one or more periodicities associated with the transaction and other data. The transaction processing server may generate a recurrent flag based on the classifying. The transaction processing server may communicate, through the application programming interface to an issuer host device, a second transaction request comprising the transaction and the recurrent flag for authenticating the transaction at the issuer host device. Via machine learning techniques, more transactions can be correctly identified as recurrent, improving the overall success rate on the execution of those transactions.

### TECHNICAL FIELD

The present application generally relates to machine learning-trained classifiers trained for data forecasting and more particularly to an engine having a machine learning-trained classifier trained to perform transaction periodicity forecast, according to various embodiments.

### BACKGROUND

Certain types of electronic transactions performed via the Internet may be executed in one of a variety of ways. In some instances, the same underlying transaction can be executed with one or more parameter flags affecting the way the transaction is handled by a transaction processor. In the case of recurring transactions (e.g. transactions between two parties executed on a regular basis), Applicant recognizes that being able to correctly identity the transaction as a recurring transaction may increase the overall rate at which those transactions successfully execute. Identifying such transactions is not always a simple task, however, and Applicant notes that there is a significant opportunity to improve the classification of electronic transactions using machine learning techniques, as discussed below.

### BRIEF DESCRIPTION OF THE DRAWINGS

FIG. 1 illustrates a block diagram of a networked system suitable for implementing the processes described herein, according to an implementation of the present disclosure;

FIG. 2 illustrates a block diagram of an example of a transaction periodicity forecast module, according to an implementation of the present disclosure;

FIG. 3 illustrates a block diagram of another example of a transaction periodicity forecast module, according to an implementation of the present disclosure;

FIG. 4 is an exemplary system environment of an artificial neural network implementing a machine learning model trained for classifications based on training data, according to an implementation of the present disclosure;

FIG. 5 is a flowchart of an example process of performing a transaction periodicity forecast, according to an implementation of the present disclosure;

FIG. 6 is a flowchart of another example process of performing a transaction periodicity forecast, according to an implementation of the present disclosure;

FIG. 7 is a flowchart of still another example process of performing a transaction periodicity forecast, according to an implementation of the present disclosure; and

FIG. 8 is a block diagram of a computer system suitable for implementing one or more components in FIG. 1, according to an implementation.

Implementations of the present disclosure and their advantages are best understood by referring to the detailed description that follows. It should be appreciated that like reference numerals are used to identify like elements illustrated in one or more of the figures, wherein showings therein are for purposes of illustrating implementations of the present disclosure and not for purposes of limiting the same.

### DETAILED DESCRIPTION

Improving the overall success rate of electronic transactions results in more efficient usage of computing resources—there is less network bandwidth used for failed requests that may later be retried, for example, and computing load is reduced on a processing server that may have to attempt to process re-tries of the transaction multiple times if the initial attempt is a failure. User device bandwidth and computing power is also saved in the event that a user computing device does not have to resubmit an electronic transaction a second (or more) time. For a billing product, electronic payment providers can increase the success rate of authenticating transactions and improve the transaction success rate for merchants that are integrated with the billing product, including different types of transactions, such as a recurrent transaction. If the service provider passes certain risk flags to an issuer, the risk flag can indicate to the issuer that a transaction is a recurring payment. Issuers can reduce their amount of risk checks and even if a payment instrument (such as a credit card) is expired, the issuer can pull the charge on a newly-issued payment card. In some cases, an electronic payment provider may rely on any identifier passed by merchant to indicate whether the transaction is recurrent since this may be open to fraudulent manipulation of the identifier, which nevertheless may require validation by the electronic payment provider. However, if an electronic payment provider can pass the risk flag along with the particular transaction to the issuer, it can improve the transaction success rate. In some aspects, aspects of the subject technology can benefit cross selling of billing products to existing express checkout merchants. For example, the electronic payment provider can identify periodic behavior on express checkout traffic for merchants, and if the electronic payment provider can detect significant portions of the billing transactions as recurring, the electronic payment provider can suggest to the merchant that they are better suited for recurrent payment solutions, which help improve both merchant and customer experiences.

There are multiple segments of merchants that may handle different types of transactions differently. The first type of merchant may be a rideshare service, such as UBER™ where a user completes a ride and may not desire to perform a manual checkout at that time. The user may have preauthorized a payment to be sent automatically each time after the user completes a ride with the service. These may be referred to as on-demand use cases. The second type of merchant may be a content delivery service provider with subscribers, such as NETFLIX™ and DROPBOX™, which are integrated with a same type of application programming interface (API) as that of the on-demand use cases. However, these particular merchants may integrate their payment scheduling engines at their end. In this respect, these merchants may call the same API as that of the on-demand use cases but the frequency at which the calls were made to the API occur at a periodic interval intended for recurrent billing. The electronic payment provider can separate these two segments of merchants, so that for those merchants and transactions that are known to be occurring as part of a periodic billing process, the electronic payment provider can begin sending out the risk flag (e.g., a recurrent transaction signal) to the issuer, and hence an improvement in the transaction success rate can be realized. But for on-demand use cases, the electronic payment provider can treat these transactions as normal traffic.

Once the electronic payment provider has determined that certain transactions are periodic in nature, the electronic payment provider may not need to perform a reactive action when an incoming transaction for payment is received by the electronic payment provider, but rather the electronic payment provider can use the information as a preventative action. Given that the transaction is determined or predicted as a periodic transaction and the transaction is expected to arrive at the electronic payment provider at (or by) a specified time from the merchant, the electronic payment provider can perform a wallet health check of a user account and notify the associated user of any potential issues with the funding source on file (e.g., a payment or gift card is expired, a payment card account is blocked, a checking account is closed, etc.) at a number of days prior to the expected arrival of the transaction from the merchant. This wallet health check can serve as an audit of any issues with the funding source on file. If an issue is found with the funding source, the electronic payment provider can send a notification to the associated user, informing the user in advance that the funding source is linked to an active subscription with the merchant, of which the payment due date is approaching due for billing, and the funding source needs to be updated for a number of reasons determined by the electronic payment provider (e.g., past due expiration date, blocked account, incorrect billing zip code, etc.). These austerity measures can help improve the success rate of the transaction.

The subject technology provides for a transaction periodicity forecast using a machine learning-trained classifier for increasing a success rate of a transaction. In some implementations, a transaction processing server may receive, through an application programming interface to a remote server, a first transaction request to process a transaction in an interaction between the remote server and a user device. The transaction processing server may classify the transaction as a recurrent transaction with a machine learning-trained classifier based at least in part on one or more periodicities associated with the transaction. For example, the transaction processing server can classify the level of periodicity of a transaction and/or classify the transaction as an on-demand transaction. The transaction processing server may generate a recurrent flag for the transaction based on the classifying. The transaction processing server may communicate, through the application programming interface to an issuer host device, a second transaction request comprising the transaction and the recurrent flag for authenticating the transaction at the issuer host device. In some aspects, the classification mechanism of the subject technology can be asynchronous and independent of other processes (e.g., business validation checks), hence latency may not be introduced in the system as the classification can occur in parallel to other existing validation operations.

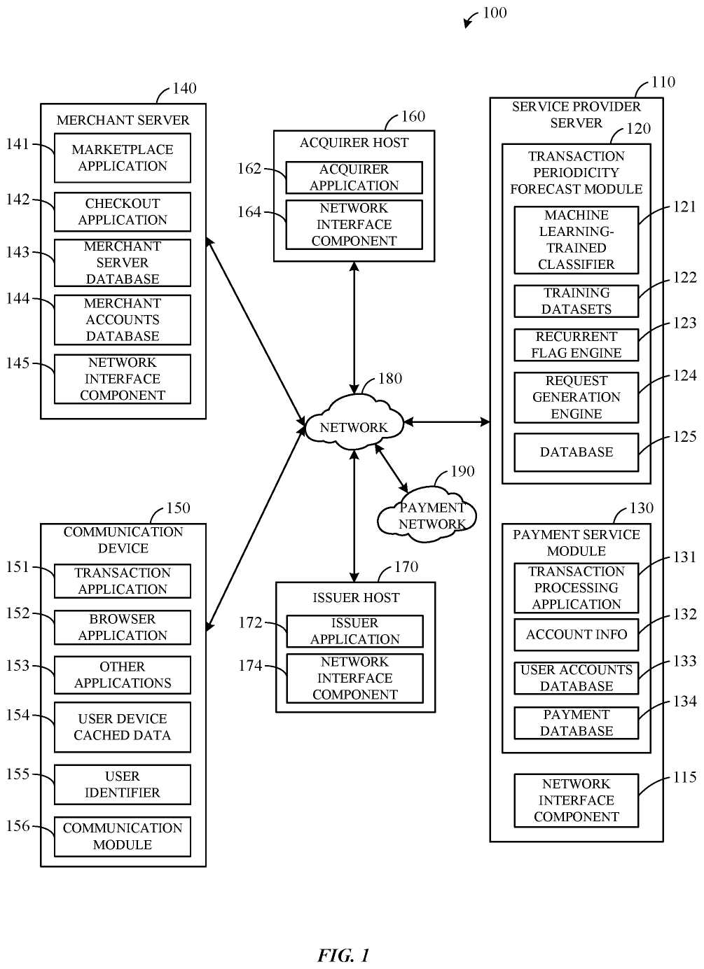

FIG. 1 illustrates a block diagram of an electronic transaction system 100 suitable for implementing the processes described herein, according to an implementation of the present disclosure. The electronic transaction system 100 includes a transaction processing or service provider server 110 associated with an electronic payment provider, a merchant server 140, and a communication device 150 that may be communicatively coupled with each other via a network 180. The electronic transaction system 100 also includes an acquirer host device 160, an issuer host device 170 and a payment network 190, communicably coupled to the service provider server 110 via the network 180. In some implementations, the service provider server 110 may be communicably coupled directly to each of the acquirer host device 160 and/or the issuer host device 170. The network 180, in one implementation, may be implemented as a single network or a combination of multiple networks. For example, in various implementations, the network 180 may include the Internet and/or one or more intranets, landline networks, wireless networks, and/or other appropriate types of communication networks. In another example, the network 180 may include a wireless telecommunications network (e.g., cellular phone network) adapted to communicate with other communication networks, such as the Internet. As used herein, the term “merchant server” may be referred to as a remote server in relation to the service provider server 110.

In various implementations, service provider server 110 includes at least one network interface component 115 adapted to communicate with merchant server 140 and/or other entities over network 180. In various implementations, network interface component 115 may include a modem, an Ethernet device, a broadband device, a satellite device and/or various other types of wired and/or wireless network communication devices including microwave, radio frequency (RF), and infrared (IR) communication devices.

The service provider server 110, in one implementation, may be maintained by a transaction processing entity or an electronic service provider, which may provide electronic services (e.g., selling of merchandise processing, purchasing of merchandise, performing electronic transactions, etc.). As such, the service provider server 110 may include a payment service module 130, which may be adapted to interact with the communication device 150 and/or the merchant server 140 over the network 180 to facilitate the searching, selection, purchase, payment of items, and/or other services offered by the service provider server 110. In one example, the service provider server 110 may be provided by PayPal®, Inc. of San Jose, Calif., USA, and/or one or more financial institutions or a respective intermediary that may provide multiple point of sale devices at various locations to facilitate transaction routings between merchants and, for example, financial institutions. In various implementations, the service provider module 130 includes a transaction processing application 131, account information 132, a user accounts database 133, and a payment database 134.

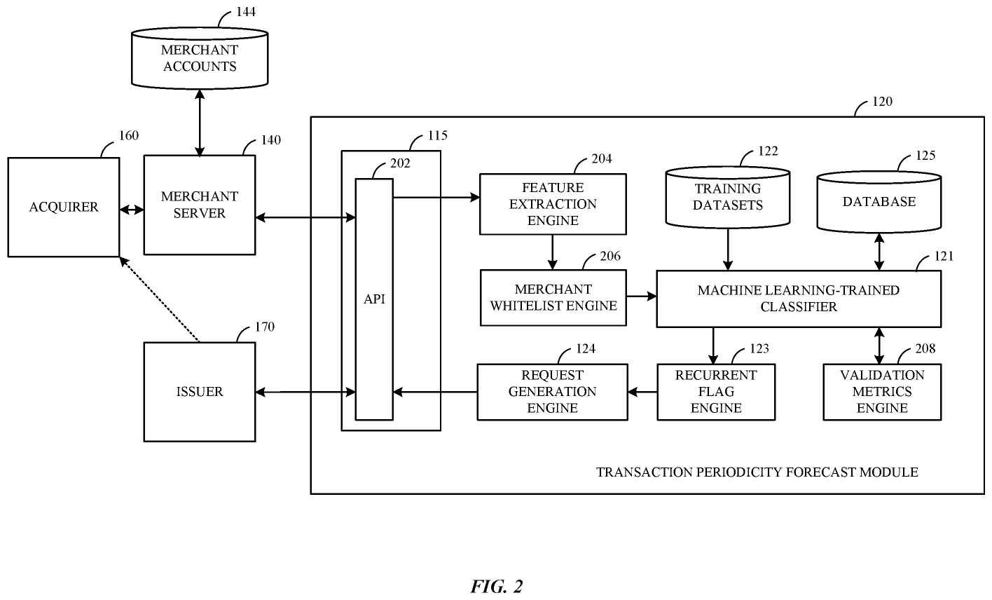

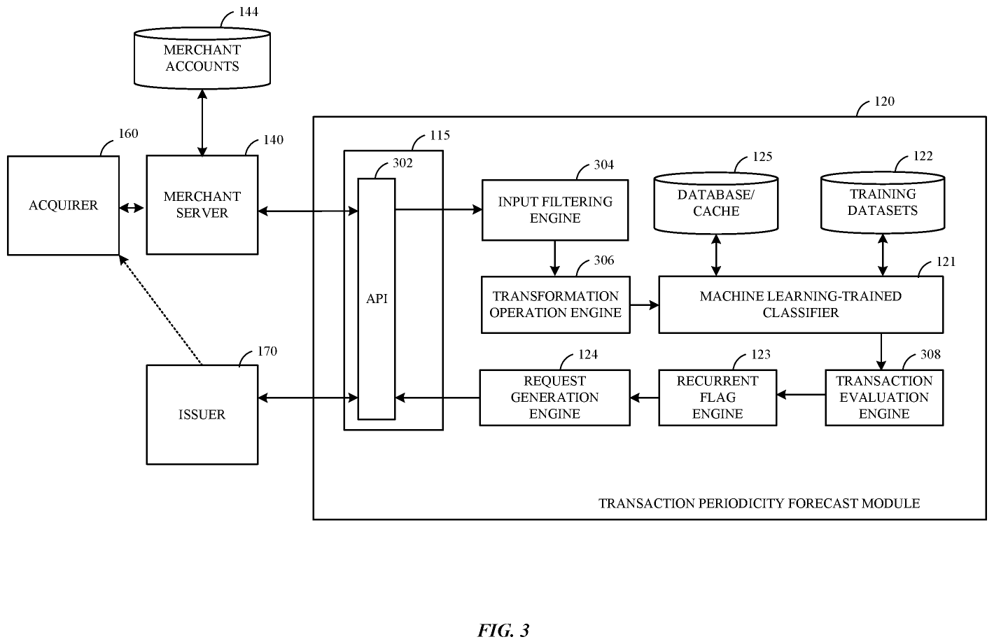

The service provider server 110 also may include a transaction periodicity forecast module 120, which may be adapted to interact with the merchant server 140 over the network 180 to facilitate the detecting, forecasting and flagging of recurrent transactions sent to the issuer host device 170 as a service offered to merchants by the electronic payment provider via the service provider server 110. The transaction periodicity forecast module 120 includes a machine learning-trained classifier 121, training datasets 122, a recurrent flag engine 123, a request generation engine 124, and a database 125, which are discussed in more detail in FIGS. 2 and 3. In some implementations, the transaction periodicity forecast module 120 is adapted to communicate with the service module 130, to the merchant server 140 and/or to the issuer host device 170 using the network interface component 115 interfaced to the service module 130, the merchant server 140 and the issuer host device 170.

The subject technology provides for transaction periodicity forecasting using the machine learning-trained classifier 121 for increasing a success rate of a transaction. In some implementations, the transaction periodicity forecast module 120 can receive, through an application programming interface (in the network interface component 115) from a remote server (e.g., the merchant server 140), a first transaction request to process a transaction in an interaction between the remote server and the communication device 150. In some aspects, the transaction periodicity forecast module 120 may determine, using an input filtering engine (not shown), whether the transaction corresponds to a first merchant category of first remote servers that invoke a number of recurrent transaction requests that is lesser than a first threshold. The transaction periodicity forecast module 120 also may pass, using the input filtering engine, the transaction to the machine learning-trained classifier for classification when the transaction is determined not to correspond to the first merchant category. In some implementations, the transaction periodicity forecast module 120 may determine, using the input filtering engine, that the transaction corresponds to the first merchant category. The transaction periodicity forecast module 120 also may determine, using the input filtering engine, whether the transaction corresponds to a second merchant category of second remote servers with a transactional behavior indicating invocation of a number of recurrent transaction requests in a transactional history of a plurality of user accounts that exceeds a second threshold. For example, the transaction periodicity forecast module 120 may rely on a holistic picture of what is the merchant's behavior with respect to other user accounts that contain a more comprehensive transactional history. The transaction periodicity forecast module 120 also may pass, using the input filtering engine, the transaction to the machine learning-trained classifier for classification when the transaction is determined to correspond to the second merchant category.

In various aspects, the transaction periodicity forecast module 120 may classify, using the machine learning-trained classifier 121, the transaction as a recurrent transaction based at least in part on one or more periodicities associated with the transaction. In some implementations, the transaction periodicity forecast module 120 may extract, using a feature extraction engine, one or more features of the transaction into a feature representation vector. In classifying the transaction, the transaction periodicity forecast module 120 also may determine, using the machine learning-trained classifier 121, whether the transaction is classified as a recurrent transaction based at least in part on an estimated hyperplane relative to one or more support vectors from the feature representation vector.

In classifying the transaction, the transaction periodicity forecast module 120 may generate, using the machine learning-trained classifier 121, an autocorrelation feature matrix for the transaction, the autocorrelation feature matrix including a plurality of correlation metrics indicating different correlations between a plurality of periodicities and a plurality of lag metrics, in which each of the plurality of lag metrics indicates an offset between a time of the transaction and a predetermined time window corresponding to one of the plurality of periodicities for providing, at least in part, an overlap between a transactional history that includes the transaction and the predetermined time window. In generating the autocorrelation feature matrix, the transaction periodicity forecast module 120 may correlate each of the plurality of periodicities against each of the plurality of lag metrics to determine a correlation metric of the plurality of correlation metrics, in which each of the plurality of correlation metrics indicates a level of correlation between a periodicity of the plurality of periodicities and a lag metric of the plurality of lag metrics.

In classifying the transaction, the transaction periodicity forecast module 120 may generate, using the machine learning-trained classifier 121, an associated tag for the transaction to classify the transaction as the recurrent transaction, the associated tag indicating a likelihood of which of the plurality of periodicities and the plurality of lag metrics are associated with the transaction. In some aspects, the recurrent flag is generated for the transaction based on the associated tag. In generating the associated tag, the system may generate a normalized probability distribution that includes a different likelihood value of a plurality of likelihood values for each pairing of a periodicity of the plurality of periodicities and a lag metric of the plurality of lag metrics, in which the associated tag comprises of the normalized probability distribution.

In classifying the transaction, the transaction periodicity forecast module 120 may generate, using a transaction evaluation engine, an adjusted time window relative to the predetermined time window based on a periodicity of the plurality of periodicities and a lag metric of the plurality of lag metrics. The transaction periodicity forecast module 120 also may determine, using the transaction evaluation engine, that the time of the transaction is within the adjusted time window.

In some aspects, the transaction periodicity forecast module 120 may generate a recurrent flag for the transaction based on the classification operation by the machine learning-trained classifier 121. The transaction periodicity forecast module 120 also may generate, using the recurrent flag engine 123, the recurrent flag based on the determining that the time of the transaction is within the adjusted time window.

The transaction periodicity forecast module 120 may communicate, using the request generation engine 124, through the application programming interface to the issuer host device 170, a second transaction request comprising the transaction and the recurrent flag for authenticating the transaction at the issuer host device.

In some aspects, the database 125 includes a transactional history associated with the remote server for a predetermined time range, in which the transactional history includes a plurality of transactions and a plurality of timestamps associated with respective ones of the plurality of transactions. In some aspects, the contents stored in the database 125 may be synchronized, at least in part, to the merchant server database 143. In some implementations, the database 125 includes a cache element to account for asynchronous processing. In some aspects, the result from recurrent flag engine 123 can be stored in the cache element and can be quickly served when requested after all business validation checks are performed to help reduce the latency in detecting periodicity in a transaction.

In some implementations, the transaction processing application 131 is adapted to process purchases and/or payments for financial transactions between a user and a merchant. In one implementation, the transaction processing application 131 assists with resolving financial transactions through validation, delivery, and settlement. As such, the transaction processing application 131 settles indebtedness between a user and a merchant, in which accounts may be directly and/or automatically debited and/or credited of monetary funds in a manner as accepted by the banking industry.

In certain embodiments, the transaction processing application 131 may allow for a user to conduct one or more transactions using the application and the electronic device. Such an application may be, for example, a dedicated purchasing application linked with a transaction service (e.g., eBay®), a merchant (e.g., Nordstrom®), and/or a payment service (e.g., PayPal® or Venmo®). The transaction processing application 131 may be a single application or a plurality of separate applications linked together. Thus, for example, the transaction processing application 131 may be a combination of a purchasing application, a payment application, and a communication application. In various embodiments, the transaction processing application 131 may also include financial applications, such as banking, online payments, money transfer, or other applications.

The payment service module 130, in one implementation, may be adapted to maintain one or more user accounts, merchant accounts, and transaction records in the user accounts database 133. As such, the user accounts database 133 may store account information associated with one or more individual users (e.g., the user associated with communication device 150) and merchants and transaction data associated with transactions. For example, account information may include private financial information of users and merchants, such as one or more account numbers, passwords, credit card information, banking information, digital wallets used, or other types of financial information. The transaction records may include Internet Protocol (IP) addresses, device information associated with the transaction, transaction dates, transaction amounts, payor identities, payee identities, etc. In certain implementations, account information also includes user purchase profile information such as account funding options and payment options associated with the user, payment information, receipts, and other information collected in response to completed funding and/or payment transactions.

In some aspects, each of the user accounts stored in the user accounts database 133 may include account information 132 associated with consumers, merchants, and funding sources, such as credit card companies. For example, account information 132 may include private financial information of users of devices such as account numbers, passwords, device identifiers, usernames, phone numbers, credit card information, bank information, or other financial information which may be used to facilitate online transactions by a user operating communication device 150. Advantageously, the payment service module 130 may be adapted to interact with merchant server 140 on behalf of a user during a transaction with the checkout application 142 to track and manage purchases made by users and which and when funding sources are used.

The transaction processing application 131, which may be part of payment service module 130 or separate, may be configured to receive information from the communication device 150 and/or merchant server 140 for processing and storage in the payment database 134. The transaction processing application 131 may include one or more applications to process information from user 105 for processing an order and payment using various selected funding instruments, as described herein. As such, transaction processing application 131 may store details of an order from individual users, including funding source used, credit options available, etc. The payment service module 130 may be further configured to determine the existence of and to manage accounts for a user, as well as create new accounts if necessary.

Merchant server 140 may include a merchant server database 143 identifying available products and/or services (e.g., collectively referred to as items) made available by, or on behalf of, a merchant associated with the communication device 150, for viewing and purchase by a non-merchant user device (not shown). According to various aspects of the present disclosure, the merchant server 140 may also host a website for an online marketplace, where sellers and buyers may engage in purchasing transactions with each other. The descriptions of the items or products offered for sale by the merchants (also referred to as “sellers”) may be stored in the merchant server database 143. The merchant may have a physical point-of-sale (POS) store front. The merchant may be a participating merchant who has a merchant account with an online marketplace provider via the merchant server 140 and a user account with the electronic payment provider via the transaction processing server 110. Merchant server 140 may be used for POS or online purchases and transactions. The merchant server 140, in various implementations, may be maintained by a business entity (or in some cases, by a partner of a business entity that processes transactions on behalf of business entity). Examples of businesses entities include an online marketplace sites, merchant sites, resource information sites, utility sites, real estate management sites, social networking sites, etc., which offer various items for purchase and process payments for the purchases. Generally, merchant server 140 may be maintained by anyone or any entity that receives money, which includes charities as well as retailers and restaurants. For example, a purchase transaction may be payment or gift to an individual. Although only one merchant server is shown, a plurality of merchant servers may be utilized if the user is purchasing products from multiple merchants.

The merchant server 140, in one implementation, may include a marketplace application 141, which may be adapted to provide information over the network 180 to the network interface component 145 of the communication device 150. For example, the user of the communication device 150 may interact with the marketplace application 141 through the network interface component 145 over the network 180 to search and view various items available for purchase in the merchant server database 143.

Merchant server 140 also may include a checkout application 142 which may be configured to facilitate the purchase by a user of goods or services online or at a physical point-of-service (POS) or store front. Checkout application 142 may be configured to accept payment information from or on behalf of the user through service provider server 110 over the network 180. For example, checkout application 142 may receive and process a payment confirmation from the service provider server 110 via the payment service module 130, as well as transmit transaction information to the payment service module 130 and receive information from the payment service module 130 (e.g., a transaction ID). Checkout application 142 may be configured to receive payment via a plurality of payment methods including cash, credit cards, debit cards, checks, money orders, or the like.

Merchant server 140 may further include the merchant server database 143 stored on a transitory and/or non-transitory memory of communication device 150, which may store various applications and data and be utilized during execution of various modules of communication device 150. Merchant server database 143 may include, for example, identifiers such as operating system registry entries, cookies associated with marketplace application 141, identifiers associated with hardware of communication device 150, or other appropriate identifiers, such as identifiers used for payment/user/device authentication or identification, which may be communicated as identifying the user/communication device 150 to service provider server 110. Merchant server database 143 may further include any transaction data sets that can be forwarded to the service provider server 110 to be used for training and/or processing with the machine learning-trained classifier 121 generated at the service provider server 110.

The merchant accounts database 144 may be adapted to store information about merchant accounts registered to merchant devices, including the communication device 150. The merchant accounts may be indicative of the merchant devices having access to a service provided by the merchant server 140. The merchant accounts database 144, in one implementation, may include at least one merchant identifier (not shown), which may be included as part of the one or more items made available for purchase so that, e.g., particular items are associated with the particular merchants. In one implementation, the merchant identifier may include one or more attributes and/or parameters related to the communication device 150, such as business and banking information. The merchant identifier may include attributes related to the merchant server 140, such as identification information (e.g., a serial number, a location address, GPS coordinates, a network identification number, etc.).

Merchant server 140 includes at least one network interface component 145 adapted to communicate with transaction processing server 110. In various implementations, network interface component 145 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 180 may be implemented as a single network or a combination of multiple networks. For example, in various implementations, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of the electronic transaction system 100.

Still referring to FIG. 1, the payment network 190 may be operated by payment card service providers or card associations, such as DISCOVER™, VISA™, MASTERCARD™, AMERICAN EXPRESS™, RUPAY™, CHINA UNION PAY™, etc. The payment card service providers may provide services, standards, rules, and/or policies for issuing various payment cards. A network of communication devices, servers, and the like also may be established to relay payment related information among the different parties of a payment transaction.

The acquirer host device 160 includes an acquirer application 162 and a network interface component 164, and is communicably coupled to the transaction processing server 110 and/or the merchant server 140 through the network interface component 164 over the network 180. The acquirer host device 160 may be a server operated by an acquiring bank. An acquiring bank is a financial institution that accepts payments on behalf of merchants. For example, a merchant may establish an account at an acquiring bank to receive payments made via various payment cards through the acquirer application 162. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction. In some implementations, when a user presents payment information to a merchant, the merchant may submit the transaction to the service provider server 110 for payment service processing. In some aspects, the service provider server 110 can host the transaction periodicity forecast model to detect the level of periodicity of the transaction. In other aspects, the service provider server 110 can expose the periodicity detection as a service to the merchant, where the merchant can host the transaction periodicity forecast model at its end and/or provide the service provider server 110 with access to its dataset and prompt the service provider server 110 to identify the periodicity of the transaction.

The issuer host device 170 includes an issuer application 172 and a network interface component 174 and is communicably coupled to the transaction processing server 110 and/or the merchant server 140 through the network interface component 174 over the network 180. The issuer host device 170 may be a server operated by an issuing bank or issuing organization of accounts and payment cards through the issuer application 172. The issuing banks may enter into agreements with various merchants to accept payments made using the accounts and payment cards. The issuing bank may issue a payment card to a user after a card account has been established by the user 105 at the issuing bank. The user then may use the payment card to make payments at or with various merchants who agreed to accept the payment card.

The communication device 150, in various implementations, may be implemented using any appropriate combination of hardware and/or software configured for wired and/or wireless communication over the network 180. In various implementations, the communication device 150 may be implemented using any appropriate hardware and software configured for wired and/or wireless communication over network 180. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data.

The communication device 150 may install and execute a transaction application 151 received from the transaction processing server 110 to facilitate one or more transaction processes (e.g., peer-to-peer payments). The transaction application 151 may allow a user to send payment transaction requests to the service provider server 110, which includes communication of data or information needed to complete the request, such as funding source information.

User device 150 may include one or more browser applications 152 that may be used, for example, to provide a convenient interface to permit a user to browse information available over network 180. For example, in one embodiment, browser application 152 may be implemented as a web browser configured to view information available over the Internet, such as a user account for online shopping and/or merchant sites for viewing and purchasing goods and/or services.

The communication device 150, in various implementations, may include other applications 153 as may be desired in one or more implementations of the present disclosure to provide additional features available to the user. For example, other applications 153 may include security applications for implementing server-side security features, programmatic client applications for interfacing with appropriate APIs over network 180, or other types of applications. Other applications 153 may also include email, texting, voice and IM applications that allow a user to send and receive emails, calls, texts, and other notifications through network 180. In various implementations, other applications 153 may include financial applications, such as banking, online payments, money transfer, or other applications associated with transaction processing server 110. Other applications 153 includes a software program, such as a graphical user interface (GUI), executable by a processor that is configured to interface to a user.

The communication device 150 may further include user device cached data 154 stored to a transitory and/or non-transitory memory of communication device 150, which may store various applications and data and be utilized during execution of various modules of communication device 150. Thus, user device cached data 154 may include, for example, identifiers such as operating system registry entries, cookies associated with browser application 152 and/or other applications 153, identifiers associated with hardware of communication device 150, or other appropriate identifiers, such as identifiers used for payment/user/device authentication or identification, which may be communicated as identifying communication device 150 to merchant server 140. In various implementations, account information and/or digital wallet information may be stored to user device cached data 154 for use by communication device 150.

The communication device 150, in one implementation, may include at least one user identifier 155, which may be implemented, for example, as operating system registry entries, cookies associated with the communication module 156, identifiers associated with hardware of the communication device 150 (e.g., a media control access (MAC) address), or various other appropriate identifiers. The user identifier 155 may include one or more attributes related to the user of the communication device 150, such as personal information related to the user (e.g., one or more user names, passwords, photograph images, biometric IDs, addresses, phone numbers, social security number, etc.) and banking information and/or funding sources (e.g., one or more banking institutions, credit card issuers, user account numbers, security data and information, etc.). In various implementations, the user identifier 155 may be passed with a user login request to the service provider server 110 via the network 180, and the user identifier 155 may be used by the transaction processing server 110 to associate the user with a particular user account maintained by the service provider server 110.

In conjunction with the user identifier 155, communication device 150 may also include a trusted zone owned or provisioned by the service provider server 110 with agreement from a device manufacturer. The trusted zone may also be part of a telecommunications provider smart card that is used to store appropriate software by the service provider server 110 capable of generating secure industry standard payment credentials as a proxy to user payment credentials.

The communication device 150 includes at least one communication module 156 adapted to communicate with the merchant server 140 and/or the service provider server 110. In various implementations, communication module 156 may include a modem, an Ethernet device, a broadband device, a satellite device and/or various other types of wired and/or wireless network communication devices including microwave, radio frequency, infrared, Bluetooth, and near field communication devices.

Even though only one communication device 150 is shown in FIG. 1, it has been contemplated that one or more user devices (each similar to communication device 150) may be communicatively coupled with the service provider server 110 via the network 180 within the networked electronic transaction system 100.

The communication device 150 may also use the merchant server 140 to communicate with the service provider server 110 over the network 180. For example, the communication device 150 may use the merchant server 140 to communicate with the service provider server 110 in the course of various services offered by the service provider to a merchant, such as a payment intermediary between customers of the merchant and the merchant itself. For example, the merchant server 140 may use an API that allows it to offer sale of goods in which customers are allowed to make payment through the service provider server 110, while the user may have an account with the transaction processing server 110 that allows the user to use the service provider server 110 for making payments to merchants that allow use of authentication, authorization, and payment services of the service provider as a payment intermediary. The merchant may also have an account with the service provider server 110. Even though only one merchant server 140 is shown in FIG. 1, it has been contemplated that one or more merchant servers (each similar to merchant server 140) may be communicatively coupled with the service provider server 110 and the communication device 150 via the network 180 in the electronic transaction system 100.

Browser application 152 may correspond to one or more processes to execute modules and associated specialized hardware of communication device 150 that provides an interface and/or online marketplace to sell one or more items offered by a merchant (not shown) associated with communication device 150, and further provide checkout and payment processes for a transaction to purchase the items for sale from the merchant corresponding to communication device 150, where such transaction processing services may be provided through payment service module 130. In this regard, browser application 152 may correspond to specialized hardware and/or software of communication device 150 to provide a convenient interface to permit a merchant to offer items for sale. For example, browser application 152 may be implemented as an application offering items for sale that may be utilized by the merchant or a merchant employee to enter items selected by a user to a transaction, determine a price for the transaction, and initiate a checkout and payment process for the transaction.

In certain implementations, browser application 152 may correspond to a website available over the Internet and/or online content and/or database information accessible through a dedicated application. Thus, browser application 152 may provide item sales through an online marketplace using the website of the merchant. However, in other implementations, communication device 150 may be local to a physical merchant location and provide transaction processing processes through interfaces displayed to a merchant or merchant employee at the merchant location. Browser application 152 may include information for a price for the item, a discount for the item, a price change for the item, and/or other incentives for items and/or with the merchant corresponding to communication device 150 (e.g., rebates, payments, etc.). Browser application 152 may be used to set and/or determine a benefit or incentive provided to a user of a communication device (not shown). The sales data and other item data may be retrievable by the communication device 150 and/or payment service module 130, such as requestable through an API call, retrievable from a database, and/or scraped from an online resource.

Browser application 152 may be used to establish a transaction once the user 105 associated with communication device 150 has selected one or more items for purchase. Once a payment amount is determined for the transaction for the item(s) to be purchased, browser application 152 may request payment from the user through a transaction processing flow provided by the payment service module 130. Browser application 152 may receive payment processing information. Thus, payment provided to the merchant account, and notification of payment (or failure, for example, where there are insufficient user funds) may be sent to browser application 152. The payment may be made by payment service module 130 on behalf of a user associated with the communication device 150. In other implementations, browser application 152 may direct the user to one or more interfaces provided by payment service module 130 for transaction processing.

Thus, browser application 152 may include one or more interfaces to engage in a transaction processing flow. In other implementations, the merchant may not view the transaction processing, which may be performed by a user associated with the communication device 150. Browser application 152 may then receive the results of the transaction processing, and complete the transaction with the user, for example, by providing the user the items for the transaction or declining the transaction where the user is not authenticated or the transaction is not authorized (e.g., insufficient funds).

In one implementation, the browser application 152 includes a browser module that provides a network interface to browse information available over the network 180. For example, the browser module may be implemented, in part, as a web browser to view information available over the network 180. The browser application 152, in one implementation, includes a user interface (e.g., a web browser, a mobile application, etc.), which may be utilized by the merchant to conduct electronic transactions (e.g., selling, perform electronic payments, etc.) with the merchant server 140 over the network 180. In one aspect, sale transactions earnings may be directly and/or automatically added to an account related to the merchant via the browser application 152.

A user, such as a consumer, may utilize communication device 150 to perform an electronic transaction using service provider server 110. For example, a user may utilize communication device 150 to visit a merchant's web site provided by merchant server 140 or the merchant's brick-and-mortar store to browse for products offered by the merchant. Further, the user may utilize communication device 150 to initiate a payment transaction, receive a transaction approval request, or reply to the request. Note that a transaction, as used herein, refers to any suitable action performed using the user device, including payments, transfer of information, display of information, etc. Although only one merchant server is shown, a plurality of merchant servers may be utilized if the user is purchasing products from multiple merchants.

In one implementation, the user may have identity attributes stored with the payment service module 130, and the user may have credentials to authenticate or verify identity with the payment service module 130. User attributes may include personal information, banking information and/or funding sources. In various aspects, the user attributes may be passed to the payment service module 130 as part of a login, search, selection, purchase, and/or payment request, and the user attributes may be utilized by the payment service module 130 to associate the user with one or more particular user accounts maintained by the payment service module 130.

FIG. 2 illustrates a block diagram of an example of the transaction periodicity forecast module 120, according to an implementation of the present disclosure. The transaction periodicity forecast module 120 includes the transaction periodicity forecast module 120 communicably coupled to the network interface component 115. The transaction periodicity forecast module 120 can interact with one or more communication devices 150, the merchant server 140 and/or the issuer host device 170 via the network interface component 115.

The transaction periodicity forecast module 120 includes a feature extraction engine 204, a merchant whitelist engine 206, a validation metrics engine 208, a recurrent flag engine 123, and a request generation engine 124. In this regard, the network interface component 115 feeds input signaling to the feature extraction engine 204, which is then fed to the merchant whitelist engine 206. The merchant whitelist engine 206 feeds its output to the machine learning-trained classifier 121, which then feeds its classification output to the recurrent flag engine 123. The recurrent flag engine 123 feeds the recurrent flag indication along with the transaction data to the request generation engine 124, which then feeds a transaction request to the issuer host device 170 via the network interface component 115.

In some implementations, the transaction periodicity forecast module 120 includes a machine learning-trained classifier 121 and a training dataset or database 122 for training the machine learning-trained classifier 121. In some aspects, the merchant whitelist engine 206 is coupled to an input to the machine learning-trained classifier 121 and the recurrent flag engine 123 is coupled to an output of the machine learning-trained classifier 121. In some examples, the input to the machine learning-trained classifier 121 may include a merchant identifier (provided by the merchant whitelist engine 206) to be used by the machine learning-trained classifier 121 to query a lookup table (or data structure) to perform a cursory classification with the indexed lookup value. In this regard, any merchants with previous transactions marked as periodic can be marked as periodic (or recurrent). In other implementations, the feature extraction engine 204 may be coupled to the input to the machine learning-trained classifier 121 and the merchant whitelist engine 206 may be coupled to the output of the machine learning-trained classifier 121.

In some aspects, the network interface component 115 includes API 202. In various aspect, the API 202 may correspond to a payment assessment API that is adapted to provide intelligence for digital payment transactions. A payment assessment API may be utilized by merchants and/or payment service providers that can leverage the power of a service provider network to authenticate and process their online transactions.

The transaction periodicity forecast module 120 may correspond to one or more processes to execute software modules and associated specialized hardware of service provider server 110 to analyze a transaction request containing transaction request data. Such transaction request data may include a network address of entities involved in a transaction. The entities, such as the communication device 150, may establish a connection to the merchant server 140 using the network address, by which the merchant server 140 acquires the network address as part of a process in registering and/or logging entities utilizing its service (e.g., uploading listings of items for sale through the online marketplace). The transaction request data may include other features and/or device attributes of the entity, such as the type of device of the entity, the screen display attributes, the user credentials stored on the entity, the type of web browser installed on the entity, or the like. The transaction request data may include information about the web browser application utilized to initiate the transaction. In some aspects, the transaction request data also may include the network address of the entity, the duration (e.g., amount of time elapsed) of the session (e.g., the connection between the communication device 150 and the merchant server 140), the login credentials utilized the entity to establish the session, cookie information indicating one or more web domains accessed by the entity during a time range, and the like. The transaction request data also may include transaction and merchant account information for a transaction and entities involved in the transaction to determine whether the transaction is eligible for a payment protection service. In this regard, the transaction periodicity forecast module 120 may correspond to specialized hardware and/or software to receive transaction information and/or access account information for assessing whether parameters included in the transaction request data satisfy one or more rules of a set of rules to determine whether the transaction is eligible to receive the payment protection service assigned by the electronic payment provider, thus increasing the user experience with the electronic payment provider platform. In some examples, the transaction information for a transaction may correspond to the name or other identifier for entities in the transaction, items involved in the transaction (e.g., sold to one or more entities), a cost of the transaction (including currency of transaction, both origin and settlement), additional costs (e.g., tax, tip, etc.), a message for the transaction (e.g., a shipping address, note to customer, item information, etc.), shipping information, and/or other information for the transaction.

The transaction periodicity forecast module 120 may receive, through the API 202 from a remote server (e.g., the merchant server 140), a first transaction request to process a transaction in an interaction between the remote server and the communication device 150. In receiving the first transaction request, the transaction periodicity forecast module 120 may receive, from the database 125, a transactional history associated with the remote server for a predetermined time range, in which the transactional history includes a plurality of transactions and a plurality of timestamps associated with respective ones of the plurality of transactions.

The transaction periodicity forecast module 120 may extract, using the feature extraction engine 204, one or more features of the transaction into a feature representation vector. In extracting the one or more features of the transaction, the transaction periodicity forecast module 120 may extract, using the feature extraction engine 204, the one or more features of each of the plurality of transactions, in which the one or more features includes features of a transaction cooperation document between the remote server and the user device that indicates whether the transaction occurs at a periodic frequency or a non-periodic frequency.

The transaction periodicity forecast module 120, using the merchant whitelist engine 206, can filter the incoming transaction requests based on their level of periodicity even though the corresponding merchants may not have an adequate transactional history. In some implementations, the merchant whitelist engine 206 may provide its output directly to the recurrent flag engine 123 (thus bypassing the machine learning-trained classifier 121) when a transaction is marked as recurrent by the merchant whitelist engine 206. If a merchant does not have a sufficient transactional history and the merchant has a relatively high periodicity level (or exceeding a periodicity level threshold), then the merchant whitelist engine 206 can mark this transaction as periodic (independent of the machine learning-trained classifier 121). Also, for certain strategic merchants invoking transaction requests at relatively high periodicity (or exceeding a periodicity threshold), the merchant whitelist engine 206 may mark all transactions of that merchant as periodic (independent of the machine learning-trained classifier 121). If none of the above conditions are satisfied with the merchant whitelist engine 206, then the merchant whitelist engine 206 passes the transaction requests to the machine learning-trained classifier 121.

In determining whether the transaction is associated with a level of periodicity, the transaction periodicity forecast module 120 may determine, using the merchant whitelist engine 206, whether the remote server invokes a number of recurrent transaction requests that exceeds a predetermined threshold based on the transactional history. The system also may add, using the merchant whitelist engine 206, the remote server to a whitelist indicating a number of remote servers that invoke recurrent transactions when the remote server is determined to invoke the number of recurrent transaction requests that exceeds the predetermined threshold. The transaction periodicity forecast module 120 may determine, using the machine learning-trained classifier 121, whether the transaction is classified as a recurrent transaction based at least in part on a measured distance between a plurality of support vectors from the feature representation vector. The transaction periodicity forecast module 120 may generate, using the recurrent flag engine 123, a recurrent flag for the transaction when the transaction is classified as the recurrent transaction. In generating the recurrent flag, the transaction periodicity forecast module 120 may determine, using the recurrent flag engine 123, whether the remote server is included in a whitelist indicating a number of remote servers classified as invoking recurrent transactions. The transaction periodicity forecast module 120 also may generate, by the recurrent flag engine 123, the recurrent flag when the remote server is included in the whitelist.

The transaction periodicity forecast module 120 may communicate, through the API 202 to the issuer host device 170, a second transaction request comprising the transaction and the recurrent flag for authenticating the transaction at the issuer host device 170. If the transaction authentication is successful, the issuer host device 170 can pass monetary funds to the acquirer host 160 associated with the merchant server 140 to obtain payment.

In some implementations, the transaction periodicity forecast module 120 may train, using at least one processor of the service provider server 110, the machine learning-trained classifier 121 with a training dataset. In some aspects, the training dataset includes different bias distributions indicating a first fraction of transactions that correspond to periodic transactions, a second fraction of transactions that correspond to non-periodic transactions, and a third fraction of transactions that correspond to a combination of periodic and non-periodic transactions. In other aspects, the different bias transactions are based, at least in part, on historical transaction data processed by the service provider server 110.

Merchant account information from the merchant accounts database 144 may also be utilized by transaction periodicity forecast module 120 to determine whether a transactional history of payments to a recipient user account (e.g., a merchant account) satisfies an expected transactional pattern and/or behavior. In some aspects, the merchant account information may include merchant and user (e.g., buyer) interactions as well as merchant and payment service provider (e.g., the service provider server 110) interactions. The merchant account information may include entity information in the merchant account, financial information, past transactions using the merchant account, account purpose and use, and other accounts interacting with the merchant account. In this regard, a merchant account for a named merchant may be utilized to determine that the transaction type is commercial instead of personal for a transaction with a previously unknown user. Similarly, past transactions between the same merchant account and different entities and/or between the same entity and different merchant accounts maintained by the merchant server 140 may be analyzed by the transaction periodicity forecast module 120, such as prior instances where a merchant account was identified by the merchant server 140 as an account that was accessed by unauthorized entities performing a one-time transaction that resulted in a monetary loss to the legitimate merchant. Additionally, it may be detected whether different merchant accounts are linked or share an entity identifier, such as the same name, address, financial information, or other information, in order to determine a pattern in the types of transactions that result in a loss exposure to the merchant server 140.

The machine learning-trained classifier 121, in one implementation, may be adapted to analyze one or more device features of the communication device 150 and generate a prediction result that indicates a likelihood that the transaction corresponds to a particular type of periodicity. In this regard, the recurrent flag engine 123 may mark the transaction with the predicted periodicity by the machine learning-trained classifier 121.

The structure of the machine learning-trained classifier 121 may include a neural network with a particular pattern of layers or number of neurons per layer that are used to provide scoring information, such as a transaction periodicity prediction. The neural network structure can be based on input components. The input components can be based on transaction data. In some aspects, the input components represent the extracted features from the transaction data. In some examples, the extracted features may include a first feature indicating a type of transaction, a second feature indicating the monetary amount involved in the transaction, a third feature indicating the recipient (or user account) and an additional feature may include a time-of-day that the transaction occurred. In other examples, the extracted features can include features indicating an agreement/consent identifier, time between successive transactions and currency. Other features may include one or more sub-features of a user-generated narrative that accompanies the transaction request. In some implementations, the structure of the machine learning-trained classifier 121 includes multiple neural networks, such that one of the neural networks is selected to perform a transaction periodicity forecast operation. In some aspects, the transaction periodicity forecast module 120 can select a prediction engine that includes a neural network among multiple prediction engines that include respective neural networks. Each of the different neural networks may correspond to a respective type of transaction periodicity.

The machine learning-trained classifier 121 may implement specific algorithms to process the transaction data to determine a transaction periodicity prediction. For example, the machine learning-trained classifier 121 may be implemented by a log regression algorithm to perform either a binary classification or multi-class classification. In other implementations, the machine learning-trained classifier 121 may be implemented with a support vector machine (SVM) algorithm. Specifically, the machine learning-trained classifier 121 may be implemented by a one-class SVM to identify if a transaction corresponds to a transaction pattern previously identified for a particular merchant, a merchant-buyer pair, billing agreement identifier, merchant-service provider pair, etc.

In some aspects, the input data to the machine learning-trained classifier 121 can be normalized, transformed, have outliers removed, or otherwise processed so that its characteristics can help the machine learning-trained classifier 121 produce quality results. The input data may be further transformed into several components to be used in the machine learning-trained classifier 121.

The machine learning-trained classifier 121 or other front-end parsing module (not shown) may generate the input components using multiple variables for a particular device. For example, the input components may be created based on an inference-based data set and predictive methodology to determine the value based on the history of similar variable combinations.

The machine learning-trained classifier 121 may be trained using the training datasets 122. The machine learning-trained classifier 121 can be trained with the transaction data already stored in the database 125 of the service provider server 110. In some implementations, aspects of the machine learning-trained classifier 121 can trained with specific subsets of the training data. The machine learning-trained classifier 121 can be trained with historical transaction data that covers a specified range of time (e.g., the last 18 months of transactions). The machine learning-trained classifier 121 can be updated with further training on later phases and through a process for periodic review. In some aspects, the training of the machine learning-trained classifier 121 may employ a form of parallel processing in order to reduce training time. For example, the training may be performed in a closed offline environment with map reduce technology.

The transaction periodicity forecast module 120 may perform post-processing and interpretation of the output data from the machine learning-trained classifier. For example, the output of the machine learning-trained classifier 121 may be transformed, normalized or run through another algorithm to provide useful output data.

Training datasets 122 may store data necessary for training and utilizing the machine learning-trained classifier 121, such as training data that may include transactions used to train the machine learning-trained classifier 121 or artificial intelligence (AI) model and any feedback from the merchant server 140 regarding a transactional history between the merchant server 140 and the communication device 150. In some aspects, training datasets 122 includes training data for transactions reviewed for satisfying any of the set of rules is accessed. The training data may correspond to data sets having different data points (e.g., transactions) that may be processed or accessible to an entity, such as those processed by an online transaction processor, financial entity, or other payment processor. In this regard, the training data may include different features and/or attributes, where these describe the transactions interacted with the communication device 150 and allow for decision-making based on the interactions with the communication device 150. Further training datasets 122 may include merchant device behavior data used for training the machine learning-trained classifier 121 for identifying any transactional patterns between the merchant server 140 and the communication device 150, identifying any anomalies in the transaction frequencies, and/or processing future transactions by the transaction periodicity forecast module 120 or another transaction processing entity, where transactions may be processed by the machine learning-trained classifier 121 to identify different types of transaction periodicities (e.g., periodic, aperiodic, combination of periodic and aperiodic) based on transaction patterns involving the communication device 150, the merchant server 140 and/or the issuer host device 170 and predict a transaction periodicity that indicates the frequency at which certain transactions occur between the merchant server 140 and the issuer host device 170.

Training datasets 122 may further include labels for the training data and/or transactions processed by the transaction periodicity forecast module 120. In some aspects, the training data labels include a description of why the machine learning-trained classifier 121 flagged particular transactions as a certain transaction periodicity. In some implementations, classifiers for the data may be designated (e.g., “recurrent transaction”) and/or the data sets may be annotated or labeled with particular transactions flagged as periodic (or recurrent). The training data may therefore include data that may be processed by agents (not shown) of the service provider server 110 or other entity to determine whether any of the transactions indicate recurrent activity or other periodic transaction behavior.

The training datasets 122 may include different features, such as a platform for the transaction (e.g., mobile, web, etc.), an account number, a transaction identifier (ID), a transaction type (e.g., payment, gambling, etc.), an encrypted transaction ID, a parent transaction ID, a created and/or update date, a US dollar equivalent amount (e.g., where credits and sent payments may be in a negative format), a local currency amount and/or code, a billing and/or shipping address, a funding source and/or backup funding source, a bank account number, a bank hash-based message authentication code (HMAC), a card number and/or hash, a card bun HMAC, a card issuer, a balance and/or impact on a balance due to the transaction, a transaction status and/or items within the transaction, notes and/or subject lines within messages for the transaction, an automated clearinghouse return codes, an ID on another marketplace or platform, a counterparty name, a counterparty account number, a counterparty account type, a counterparty country code, a counterparty email, a counterparty transaction ID, a counterparty ID on a marketplace or platform, a counterparty account status, a referring URL, an IP address, whether the transaction was successful, and a date (e.g., month/year) of transaction.

In some implementations, the validation metrics engine 208 is adapted to collect validation metrics and can be used to retrain and fine-tune the machine learning-trained classifier 121, either online or offline. In this regard, any new transactions requests received from the merchant server 140 at the transaction periodicity forecast module 120 can serve as true labels and the predicted payment date (output from the machine learning-trained classifier 121) can serve as predicted labels. The machine learning-trained classifier 121 can then be retrained with the collected validation metrics to account for any new information and improve its accuracy over time.

In operation, the transaction periodicity forecast module 120 can compute a recurrent flag based on a transaction. The recurrent flag can notify the issuer host device 170 whether a particular transaction is recurring or not. In some aspects, the merchant transactions are computed offline. The service provider server 110 can store all of the transaction datasets of historical transactions that are available in the database 125. The service provider server 110, using the transaction periodicity forecast module 120, can run jobs to process the data, aggregate the data, and obtain insights into the transactions data. In some aspects, the transaction periodicity forecast module 120, using the machine learning-trained classifier 121, can identify merchants whose threshold number of transactions are actually occurring as recurrent. The machine learning-trained classifier 121 can infer that these identified merchants are using the billing product primarily (or entirely) for recurring transactions. For this segment of merchants, the service provider server 110, using the transaction periodicity forecast module 120, can process the historical transactions for the past predetermined time range (e.g., last 18 months), determine which merchants have more than a predetermined percentage (e.g., 90%) of their incoming transactions as periodic. For merchants classified (using the transaction periodicity forecast module 120) as periodic, the transaction periodicity forecast module 120, using the merchant whitelist engine 206, can add the classified merchants to a “whitelist.” Any transactions arriving to the transaction periodicity forecast module 120 from merchants in the whitelist, can be marked as periodic. As such, the transaction periodicity forecast module 120, using the recurrent flag engine 123, sets the recurrent flag for these whitelisted transactions.

The transaction periodicity forecast module 120, using the request generation engine 124, can send a payment request with the recurrent flag set to the issuer host device 170. The payment request can indicate the payment amount, the receiver and buyer as well as flags. These flags include the recurrent flag.

For purposes of evaluation, the transaction periodicity forecast module 120, using the machine learning-trained classifier 121, can accept a feature representation (or feature vector) of a data point (e.g., a transaction). For a given billing agreement ID, the transaction periodicity forecast module 120, using the machine learning-trained classifier 121, can receive and process all the timestamps in order at when the transactions occur for that billing agreement ID. The transaction periodicity forecast module 120, using the machine learning-trained classifier 121, then computes a “days-since-last” metric. This time-based metric indicates that if a transaction occurred on the first day of a given billing month, then the subsequent transaction should occur on the first day of the next month, and so on. The “days-since-last” metric can include two or more values: 31 days and 28 days. For example, 1^{st} of February minus 1^{st} of January corresponds to 31 days, and the 1^{st} of March minus the 1^{st} of February corresponds to 28 days. From a given billing agreement ID, the number of days-since-last may correspond to the number of transactions minus 1. The transaction periodicity forecast module 120, using the machine learning-trained classifier 121, can then compute the statistical spread of that days-since-last. For example, if every transactions period is 30 days, then the average value is 30 with a variance of 0. Similarly, if the transactions occur all over the place and the transactions appear aperiodic, then the summation of the variances and the transaction frequency averages may have a higher statistical spread. The statistical spread of days-since-last can represent how consistently periodic the transactions occur within a given time period. The transaction periodicity forecast module 120 may not be limited to the days-since-last metric. In some aspects, the metric can be a combination of the remainder of the periodicity. In some implementations, the machine learning-trained classifier 121 primarily considers the 30-day type of periodicity. There may be some use cases where the merchants indicate multiple cycles and/or a skipped cycle. In this case, the days-since-last may appear as 30-31, 30-31 and then 61. The last figure may be 61 because the user may have been charged the next month for two months after incurring the charge. In some implementations, this number can be divided by 30 to determine a fractional dip cycle.

In some implementations, the days-since-last statistical distribution becomes the feature vector, which is fed into the machine learning-trained classifier 121. To begin with the prior interactions between the electronic payment provider (e.g., the service provider server 110) and merchants (e.g., merchant server 140), the service provider server 110 may determine in advance that some of the accounts had periodic transactions. In some aspects, the transaction periodicity forecast module 120 receives the merchant data and stores it as the training datasets 122. The transaction periodicity forecast module 120 can receive transaction details, evaluate the feature vector of those transactions, and mark that data as positive use cases with supervised learning. In this regard, any transaction that does not fall on that statistical distribution can be marked as a negative use case. The transaction periodicity forecast module 120 may then apply the machine learning-trained classifier 121 (as a trained model) on the remaining merchants in the regular transaction dataset. Merchants with more than a predetermined percentage of transactions marked as periodic can be extracted from that dataset. In some aspects, the predetermined percentage can be a variable value or system defined.

The transaction periodicity forecast module 120 may not look for different types of periodicities, because some merchants integrated with the same API (e.g., 202), use the same account, the same billing agreement identifier (ID) to perform on-demand transactions and periodic transactions or these merchants have two billing cycles on the same recurrent ID. An example use case may be a merchant, such as GOOGLE™, that charges a user every month or annually for a GOOGLE™ Drive subscription. But on the same billing agreement, the merchant may be charging the user for a movie played back on a content delivery service, such as YOUTUBE™. Therefore, it may be desirable to identify these two types of transaction periodicities operating on the same billing agreement. In the first use case, the machine learning-trained classifier 121 operating as a SVM model, aggregated transactions at the merchant identifier level. As discussed above, the predetermined threshold for classification may be set to 90%+ transactions with merchants classified as recurrent billing as to when the recurrent flag would be passed to issuer host device 170. However, there may be merchants having 60% traffic operating as recurrent (or periodic) transactions and 40% operating as on-demand transactions. In this respect, the SVM model at the 90%+ threshold would overlook these types of merchants, so therefore it is desirable to classify based on transactions rather than merchants.

FIG. 3 illustrates a block diagram of another example of the transaction periodicity forecast module 120, according to an implementation of the present disclosure. The transaction periodicity forecast module 120 includes an input filtering engine 304, a transformation operation engine 306, a transaction evaluation engine 308, the recurrent flag engine 123, and the request generation engine 124. In this regard, the network interface component 115 feeds input signaling to the input filtering engine 304, which is then fed to the transformation operation engine 306. The transformation operation engine 306 feeds its transformation output to the machine learning-trained classifier 121, which feeds its classification output to the transaction evaluation engine 308. The transaction evaluation engine 308 feeds its evaluation output to the recurrent flag engine 123. The recurrent flag engine 123 feeds a recurrent flag indication along with the transaction data to the request generation engine 124, which then feeds a transaction request to the issuer host device 170 via the network interface component 115.

In some implementations, the transaction periodicity forecast module 120 includes a machine learning-trained classifier 121 and a training datasets database 122 for training the machine learning-trained classifier 121. In some aspects, the input filtering engine 304 is coupled to an input to the machine learning-trained classifier 121 and the transaction evaluation engine 308 is coupled to an output of the machine learning-trained classifier 121.

In some aspects, the network interface component 115 includes API 302. In various aspect, the API 302 may correspond to a payment assessment API that is adapted to provide intelligence for digital payment transactions. A payment assessment API may be utilized by merchants that can leverage the power of a service provider network to authenticate and process their online transactions.

In some implementations, the transaction periodicity forecast module 120, using the input filtering engine 304, may receive, from the merchant server 140 through the API 302, a first transaction request to process a transaction in an interaction between the merchant server 140 and the communication device 150. In some implementations, the transaction periodicity forecast module 120, using the input filtering engine 304, may determine whether the transaction corresponds to a first merchant category of first remote servers that invoke a number of recurrent transaction requests that is lesser than a first threshold. The transaction periodicity forecast module 120, using the input filtering engine 304, also may pass the transaction for classification when the transaction is determined not to correspond to the first merchant category. In other aspects, the transaction periodicity forecast module 120, using the input filtering engine 304, may determine that the transaction corresponds to the first merchant category and determine whether the transaction corresponds to a second merchant category of second remote servers with a transactional behavior indicating invocation of a number of recurrent transaction requests in a transactional history of a plurality of user accounts that exceeds a second threshold. The transaction periodicity forecast module 120, using the input filtering engine 304, also may pass the transaction for classification when the transaction is determined to correspond to the second merchant category.

The transaction periodicity forecast module 120, using the transformation operation engine 306, may determine a correlation between a plurality of periodicities and a plurality of lag metrics from the transaction using a transformation operation on the plurality of periodicities and the plurality of lag metrics. In determining the correlation, the transaction periodicity forecast module 120, using the transformation operation engine 306, may generate an autocorrelation feature matrix for the transaction. In some aspects, the autocorrelation feature matrix includes a plurality of correlation metrics indicating different correlations between the plurality of periodicities and the plurality of lag metrics, in which each of the plurality of lag metrics indicates an offset between a time of the transaction and a predetermined time window corresponding to one of the plurality of periodicities for providing, at least in part, an overlap between a transactional history that includes the transaction and the predetermined time window. In some implementations, in generating the autocorrelation feature matrix, the transaction periodicity forecast module 120, using the transformation operation engine 306, may correlate each of the plurality of periodicities against each of the plurality of lag metrics to determine a correlation metric of the plurality of correlation metrics, in which each of the plurality of correlation metrics indicates a level of correlation between a periodicity of the plurality of periodicities and a lag metric of the plurality of lag metrics.

The transaction periodicity forecast module 120, using the machine learning-trained classifier 121, may generate an associated tag for the transaction to classify the transaction as a recurrent transaction. In some aspects, the associated tag indicates a likelihood of which of the plurality of periodicities and the plurality of lag metrics are associated with the transaction. In generating the associated tag, the transaction periodicity forecast module 120, using the machine learning-trained classifier 121, may generate a normalized probability distribution that includes a different likelihood value of a plurality of likelihood values for each pairing of a periodicity of the plurality of periodicities and a lag metric of the plurality of lag metrics, in which the associated tag comprises of the normalized probability distribution.

The transaction periodicity forecast module 120, using the recurrent flag engine 123, may generate a recurrent flag for the transaction based on the associated tag. In some implementations, the transaction periodicity forecast module 120, using the transaction evaluation engine 308, may generate an adjusted time window relative to the predetermined time window based on a periodicity of the plurality of periodicities and a lag metric of the plurality of lag metrics. The transaction periodicity forecast module 120, using the transaction evaluation engine 308, also may determine that the time of the transaction is within the adjusted time window. In generating the recurrent flag, the transaction periodicity forecast module 120, using the recurrent flag engine 123, may generate the recurrent flag based on the determining that the time of the transaction is within the adjusted time window.

The transaction periodicity forecast module 120, using the request generation engine 124, may communicate a second transaction request that includes the transaction and the recurrent flag for authenticating the transaction at the issuer host device 170.

Based on the transactions gathered as described in FIG. 2, the transaction periodicity forecast module 120, using at least one processor (not shown), may execute an automated script to simulate the received transactions. Among the dataset fed into the machine learning-trained classifier 121 of the first approach, there may be a set of use cases that include failed attempts in which a transaction retry occurs, skipped cycles, and/or multiple periodicities (e.g., monthly, bi-weekly, 28-day, semi-monthly). The common periodicities that merchants use from a subscription point-of-view are the periodicities considered by the transaction periodicity forecast module 120. The automated script can attempt to emulate this processing based on the failure rates (referred to as the probability of the transaction attempting a retry for authentication, and after the first retry there is a probability of it failing and then attempting a second retry). These merchants may retry the transaction the next day, the following day, the day after that, and so on. The machine learning-trained classifier 121 can take into account these observed transaction patterns. The automated script can generate between 100 k-200 k emulated transactions. These transactions are then tagged by the transaction periodicity forecast module 120 with the appropriate periodicity. Examples of periodicities include purely aperiodic (not periodic), purely single periodicity, mixed-case periodic and aperiodic, two periodicities, and so on. All of these different use cases can be generated from the automated script.

In some implementations, the transaction periodicity forecast module 120 can evaluate against each dataset and provide associated tags that describe what type of periodicity it is and what is the lag of the probabilities on the day the transaction was initiated. As used herein, the term “lag” refers to an offset between a predetermined time interval that corresponds to a type of periodicity and a time when the transaction is generated. In some aspects, a series of timestamps can be generated when the transactions occur. When the timestamps are generated, there may be a peak observed on a day of the transaction occurrence and the other days are flat as observed along an x-axis (or time axis). There can be multiple peaks on different days along the x-axis indicating multiple transactions occurring on the different days respectively. If the transaction periodicity forecast module 120, using the transaction evaluation engine 308, overlays a window of 30 days, in which there is a slit at every 30-day interval, if the transaction evaluation engine 308 moves the 30-day window along the time axis of a transaction distribution, then the transaction evaluation engine 308 may detect a peak at every 30 days with the other days being flat. This finding correlated with the underlying dataset can indicate how strongly the transaction correlates to a given periodicity. Based on that, from the date of the first timestamp, the transaction evaluation engine 308 can determine how many days the window shifted to observe the overlap with the underlying dataset, which indicates the lag of the periodicity. The dataset generated from the automated script can includes timestamp, labels of the type of periodicity, and the lag of the periodicity.

In some implementations, the machine learning-trained classifier 121 is a feed-forward network. The machine learning-trained classifier 121 can utilize a back-propagation network for feedback/retraining. During a training phase, the machine learning-trained classifier 121 may have computed all the correlations between different periodicities and different lags. These correlation computations may be sent out as the input layer of the machine learning-trained classifier 121. Given a list of timestamps, the machine learning-trained classifier 121 may determine what is the correlation of each window and its lag. For example, an input window may consist of multiple day ranges, such as 7+14+15+28+30+31, with each day range being a correlation value. This is fed through the machine learning-trained classifier 121. The machine learning-trained classifier 121 output maps to the corresponding tag values and error tag. Each tag value may have a normalized probability distribution. In this respect, every tag can receive a value between 0 and 1, and the sum of all tag values adds up to 1. In some aspects, the transaction evaluation engine 308 may receive a prediction value of what is the probability that this tag is the correct value or not, and then the transaction evaluation engine 308 may evaluate the error rate between the presented value and the actual value. The transaction evaluation engine 308 may then calculate the log loss from the error rate. In some implementations, there may be a backpropagation feedback channel to the machine learning-trained classifier 121. In this respect, the log loss can be used for gradient descent in the backpropagation.

The input to the machine learning-trained classifier 121 may include the correlation vector that includes correlations against each of the lag inputs. In a new sample input, using the machine learning-trained classifier 121, the machine learning-trained classifier 121 can evaluate the correlation vector by feeding the vector to the machine learning-trained classifier 121, the machine learning-trained classifier 121 then generates a probability value for each associated tag. In some aspects, there may be a threshold cutoff so that the probability value collapses between a 0-to-1 value. In some aspects, an activation function (e.g., sigmoid, rectified linear unit (ReLU)) may be applied to the machine learning-trained classifier 121 during the training phase so that the output values are bounded between 0 and 1. The output of the machine learning-trained classifier 121 may include (or indicate) that the actual tags associated with a particular data sample is “28_2”, which implies that it is a 28-day periodicity with a lag of 2 days. Once a tag is extracted and classified in an assigned category (or class), the model based on from the timestamp of the first transaction, the transaction periodicity forecast module 120 can create a window of 28 days. Then with a lag of 2, the transaction periodicity forecast module 120 can determine all of the days that fit within the window. For any new incoming transaction that falls within any one of these windows, the new incoming transactions can be treated as a periodic transaction. In some aspects, the set of windows can include an error window of ±1 day.

With every single transaction that is arriving at the service provider server 110, the payment service can pass historical timestamps that relate to that transaction. The transaction periodicity forecast module 120 can utilize the historic timestamp and the current timestamp day. The historic timestamp can be utilized to evaluate whether the particular transaction falls under the periodic transaction category or not, and if a lag (or a window) is identified, then that window is applied to the start date. Once this is identified, the transaction periodicity forecast module 120, using the transaction evaluation engine 308, then evaluates whether the current timestamp falls within one of those windows as well. If it does, this results in the issuance of a recurrent flag by the recurrent flag engine 123. Because the simulated dataset already contains sampled sets of multiple periodicities, single periodicities, single aperiodicities (e.g., mixed of periodic with one or more one-time transactions), on-demand (e.g., one-time transactions), and so on, noise transactions also can be omitted.

In some implementations, bias is introduced as part of the training datasets 122. The training datasets 122 can have different bias distributions indicating what fraction of transactions is observed as periodic, is observed as non-periodic, etc. These biases can be translated as part of the training phase itself. Within the machine learning-trained classifier 121 itself there can be certain biases introduced. The biases can be based on the historical transaction data processed by the payment service module 130.

In some implementations, the raw data provided to the machine learning-trained classifier 121 can include a list of historic timestamps. Thereafter, the transaction periodicity forecast module 120, using the transformation operation engine 306, applies a transformation operation on the list of transactions (provided that the list of transactions qualifies for running the model or not). For any transaction to be classified as (or to be evaluated for periodicity), the transaction may need to satisfy two conditions: (1) the transaction may not correspond to a merchant category that has a number of periodic transactions lesser than a first threshold; and (2) the transaction is from an existing merchant and the number of transactions for that particular merchant is greater than a second threshold. In regard to the first factor, for example, if the transaction is initiated by a merchant with a rideshare service, the transaction periodicity forecast module 120 may already know that there is a very small percentage of transactions that are periodic from this merchant. In some aspects, the transaction periodicity forecast module 120 may evaluate the transaction history of this merchant. If the transaction periodicity forecast module 120 determines that the transaction history only contains a small number of transactions, such as 2 or 3 transactions, then the transaction periodicity forecast module 120 may not treat these transactions as periodic. In regard to the second factor, for example, a merchant may have 10 transactions, and the threshold may be set to 5 transactions, so if the merchant has more than 5 transactions (or exceeds the threshold), then the input filtering engine 304 can feed that transaction to the machine learning-trained classifier 121 for evaluation. A third use case is that the merchant has too few transactions but the merchant has a new subscriber that does not have a transaction history with a user account (e.g., the incoming transaction may be the first transaction or the user account may include 2 transactions in its transaction history). In this case, the transaction periodicity forecast module 120 may rely on a holistic picture of what is the merchant's behavior with respect to other user accounts that contain a more comprehensive transactional history. In this regard, if more than 90% of the other user transactions are consistent with a periodic behavior, then the transaction associated with the new user can qualify for evaluation by the machine learning-trained classifier 121. Although the new user transactional history may not have qualified the transaction for periodicity evaluation, but for the other users' transactional behavior for that particular merchant, the new user transaction can be passed to the machine learning-trained classifier 121 for periodicity evaluation.

Once this input is passed to the machine learning-trained classifier 121 after the input filtering step (e.g., 304), the transformation operation is performed by the transformation operation engine 306. The transformation operation may include generating an autocorrelation feature matrix. From those timestamps, the autocorrelation feature matrix can identify how well the signals correlate to a 7-day with zero lag, to a 7-day window with 1-day lag, to a 7-day window with 2-day lag, and so on. This can be similarly done for all of the other periodicities (e.g., 7, 14, 15, 28, 30, 31), where a 7-day lag may correspond to a 7-day-periodicity-to-0-day lag so the machine learning-trained classifier 121 can compute from a 7-day window with an autocorrelation from 0 to 6, for example. In some implementations, the autocorrelation feature matrix may represent the input layer of the machine learning-trained classifier 121. The input layer may be interconnected with the other inner layers of the machine learning-trained classifier 121, where one or more weights may be applied. The final output layer of the machine learning-trained classifier 121 may correspond to the generated tags that indicate a probability of which periodicity and lag the transaction is associated with. In some aspects, on-demand transactions on a periodic transaction can be identified with a non-periodic transaction tag. The associated tag can be taken as the output of the machine learning-trained classifier 121 along with the current timestamp. If the tag is determined to be a periodic transaction tag, then the current timestamp is used to evaluate whether the current timestamp falls into that current tag window or not.

The process of evaluating a transaction for a type of periodicity can be initiated by a transaction call related to a request for payment services with the service provider server 110. For example, this process may be triggered by the notification to the service provider server 110 that the transaction is pending processing at the merchant server 140. The service provider server 110, using the payment service module 130, can fetch a user history and merchant preferences to extract a corresponding transaction history, where that merchant may have a billing agreement in place to determine the historic transactions (and timestamps) that have occurred along with the payment amount and currency designation. Once the payment service module 130 gathers this data, the transaction periodicity forecast module 120 can receive this request and passes the request to a periodic classification service (e.g., the machine learning-trained classifier 121) that is asynchronous and deferred (e.g., may be performed offline) because the model computations can be costly and time consuming and may add latency to the processing. In some aspects, the transaction request input may be preprocessed by the input filtering engine 304 and the transformation operation engine 306, which prepare results prior to sending to the machine learning-trained classifier 121. By the time a transaction request is received, the transaction request is processed by several sub-services of the transaction periodicity forecast module 120 before being sent to the issuer host device 170 by the last service (e.g., request generation engine 124). The first service that receives the transaction request (e.g., the input filtering engine 304) may initiate the request to the machine learning-trained classifier 121 to compute the result. The last service may initiate a request to get the computed results back, which is already cached in mid-flight by a caching service (e.g., the database 125). Effectively by the time the service reaches the last layer, if the results are not ready (the service attempts to avoid latency to the processing and adversely impact the user experience), the service may time out after a predetermined latency delay. In this case, the request generation engine 124 may transmit the request without the recurrent flag to the issuer host device 170. Otherwise, in most cases, the request generation engine 124 can have the results ready from the machine learning-trained classifier 121 to be sent out to the issuer host device 170.

In the case where the timeout occurs and the data is sent to the issuer host device 170 without the recurrent flag set, the request generation engine 124 may not send (afterward) the missing recurrent flag. In some aspects, the recurrent flag may be sent as part of a transaction retry by the issuer host device 170, depending on the issuer declined code. If the issuer host device 170 declines a transaction because of a timeout (caused by delay of the transaction periodicity forecast module 120), the payment service module 130 may retry the transaction. However, if the issuer host device 170 declined the transaction because user funds are not available (e.g., credit card balance exceeds limit, account contains no funds, etc.), the issuer hot device 170 may issue a decline code that may not be remedied by performing a transaction retry. In this respect, the payment service module 130 may not retry the transaction, and may propagate the same error code (or decline code) back to the merchant server 140. In other implementations concerning occurrence of a timeout, there may be a list of fallback options that the transaction periodicity forecast module 120 can perform. For example, if a timeout occurs, the transaction periodicity forecast module 120 can fall back to merchant-level aggregation (which relates to the embodiment described in FIG. 2), which refers to analyzing whether, for a particular merchant, the transaction is periodic or not. If it is determined that the transaction is periodic based on the merchant-level analysis, the recurrent flag is sent. In some implementations, the transaction periodicity forecast module 120 can process the periodicity classification service as a three-step system, where the transaction periodicity forecast module 120 sends the recurrent flag as a first fallback option, the transaction periodicity forecast module 120 defers to merchant-level aggregation analysis to send the recurrent flag as a second fallback option, or the transaction periodicity forecast module 120 may not send the recurrent flag at all as a third fallback option.

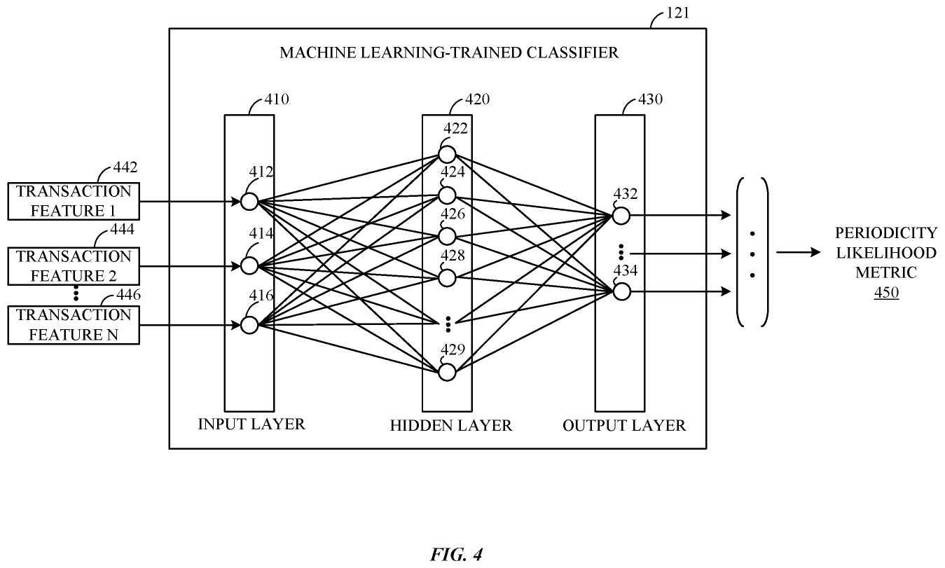

FIG. 4 is an exemplary system environment of the machine learning-trained classifier 121 or an artificial neural network implementing a machine learning model trained for classifications based on training data (e.g., a model trained using training datasets 122 of transactions having a distribution of transactions with different periodicities), according to an implementation of the present disclosure. In this regard, machine learning-trained classifier 121 shows an input layer 410, a hidden layer 420, and an output layer 430 of the artificial neural network implementing a machine learning model trained as discussed herein, where the nodes and weights for the hidden layer may be trained using one or more training data sets of transactions for identification of patterns of prohibited conduct or behavior in transaction performance (e.g., transaction processing between users or other entities).

For example, when training machine learning-trained classifier 121, one or more training data sets of training datasets 122 for transactions having different features and feature values may be processed using a supervised machine learning algorithm or technique, such as gradient boosting or random forest algorithms. In some implementations, other types of AI learning may be used, such as deep learning for neural networks. The features within training datasets 122 may include different types of variables, parameters, or characteristics of the underlying transactions, which may have separate values to the variables. This allows for different classifiers of the transactions and variables to be built into known or desired classifications (e.g., certain transaction periodicity). These classifiers are trained to detect the transactions of training datasets 122 falling into the classifier using the machine learning technique, which allows identification of similar transactions meeting a specific classification. The classifiers may be generated by the machine learning technique when identifying and grouping transactions and/or designated by a user or agent of the training data set. Thus, training datasets 122 may include transactions falling into specific classifications, such as non-periodic transaction or periodic transaction. The process may be supervised where the output and classifications are known for the transactions. In some implementations, the training data set may include annotated or labeled data of particular flagged transactions and/or may be reviewed after processed and classified by the machine learning technique for false positives and/or correctly identified and flagged as a certain transaction periodicity.

Machine learning-trained classifier 121 includes different layers and nodes to perform decision-making using the machine learning-trained classifier 121. Each of layers 410, 420, and 430 may include one or more nodes. For example, input layer 410 includes nodes 412-416, hidden layer 420 includes nodes 422-429, and output layer 430 includes nodes 432-434. In this example, each node in a layer is connected to every node in an adjacent layer. For example, node 412 in input layer 410 is connected to all of nodes 422-429 in hidden layer 420. Similarly, node 422 in the hidden layer is connected to all of nodes 412-416 in input layer 410 and nodes 432-434 in output layer 430. Although only one hidden layer is shown, it has been contemplated that a neural network used to implement the machine learning-trained classifier 121 for transaction periodicity forecasting may include as many hidden layers as desired.

In this example, machine learning-trained classifier 121 receives a set of input values (e.g., transaction features 442-446) and produces an output vector (or singular value). Each node in input layer 410 may correspond to a distinct input value. For example, when a neural network is used to implement the machine learning-trained classifier 121 for transaction periodicity, each node in the input layer 410 may correspond to a distinct attribute derived from the information associated with a user device (e.g., communication device 150) or a user account. In some aspects, the information pertains to a transaction (e.g., a transaction time, currency amount, recipient, USD equivalent amount, balance affect or account balance, local or general time/date, etc.). In a non-limiting example, node 412 receives transaction feature 442 (depicted as “transaction feature 1”) that may correspond to an account identifier or name, node 414 receives transaction feature 444 (depicted as “transaction feature 2”) that may correspond to a network address used by a sending or receiving merchant account, and node 416 receives transaction feature 446 (depicted as “transaction feature N”) that may correspond to an amount for the transaction. In some aspects, the nodes 412-416 may correspond to an encoded value representing a set of additional values derived from training datasets 122. In some implementations, the machine learning-trained classifier 121 may compute all the correlations between different periodicities and different lags. These correlation computations may be sent out as the input layer 410.

In some implementations, each of nodes 422-429 in hidden layer 420 generates a representation, which may include a mathematical computation (or algorithm) that produces a value based on the input values received from nodes 412-416. The mathematical computation may include assigning different weights to each of the data values received from nodes 412-416. In some instances, the weights can be identified based on the relevance to a particular transaction periodicity. For example, nodes 422-429 may include different algorithms and/or different weights assigned to the data variables from nodes 412-416 such that each of nodes 422-429 may produce a different value based on the same input values received from nodes 412-416. In some implementations, the weights that are initially assigned to the features (or input values) for each of nodes 422-429 may be randomly generated (e.g., using a computer randomizer). The values generated by nodes 422-429 may be used by each of nodes 432-434 in output layer 430 to produce an output value for machine learning-trained classifier 121. When a neural network is used to implement the machine learning-trained classifier 121 for transaction periodicity forecasting, the output value produced by the neural network may indicate a likelihood that a transaction has a particular transaction periodicity. In some aspects, the neural network may output a vector of likelihood values, where each likelihood value pertains to a different transaction periodicity.

The machine learning-trained classifier 121 may be trained by using historical electronic transaction data (training data). The historical electronic transaction data may include transaction records for different time periods in the past (e.g., July 2019 through March 2020, July 2018 through March 2019, July 2017 through March 2020, etc.). By providing the training data to the artificial neural network 400, the nodes 422-429 in the hidden layer 420 may be trained (adjusted) such that an optimal output (e.g., a likelihood of a transaction having a particular transaction periodicity at a particular time with respect to a recipient merchant account) is produced in the output layer 430 based on the training data. For example, the output layer 430 can produce a transaction periodicity likelihood metric 450 that includes the optimal output of the artificial neural network 400. In some aspects, the transaction periodicity likelihood metric 450 is a vector of likelihood values. In other aspects, the transaction periodicity likelihood metric 450 is a singular value. By continuously providing different sets of training data and penalizing the machine learning-trained classifier 121 when the output is incorrect, the machine learning-trained classifier 121 (and specifically, the representations of the nodes in the hidden layer 420) may be trained (adjusted) to improve its performance in transactions for different periodicities over time. Adjusting the machine learning-trained classifier 121 may include adjusting the weights associated with each node in the hidden layer 420.

Although the above discussions pertain to an artificial neural network as an example of machine learning, it is understood that other types of machine learning methods may also be suitable to implement the various aspects of the present disclosure. For example, support vector machines (SVMs) may be used to implement machine learning. SVMs are a set of related supervised learning methods used for classification and regression. A SVM training algorithm—which may be a non-probabilistic binary linear classifier—may build a model that predicts whether a new example falls into one category or another. As another example, Bayesian networks may be used to implement machine learning. A Bayesian network is an acyclic probabilistic graphical model that represents a set of random variables and their conditional independence with a directed acyclic graph (DAG). The Bayesian network could present the probabilistic relationship between one variable and another variable. Other types of machine learning algorithms are not discussed in detail herein for reasons of simplicity.

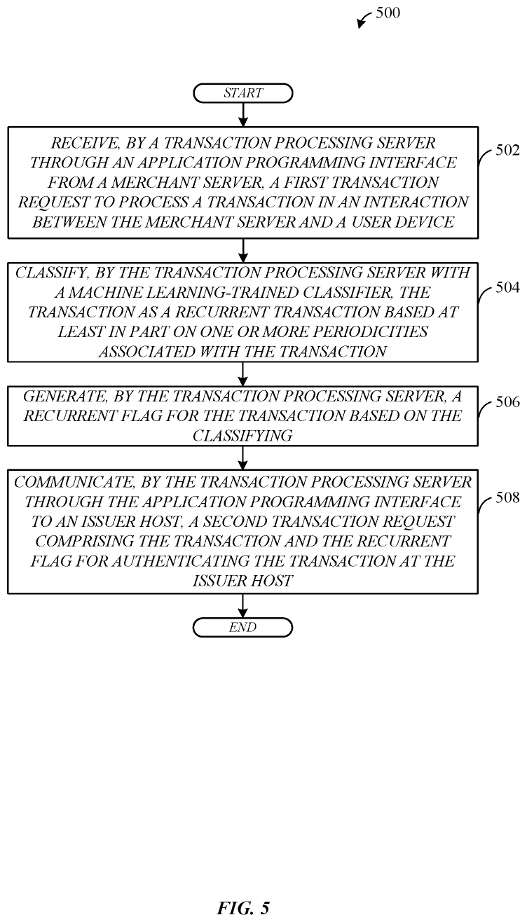

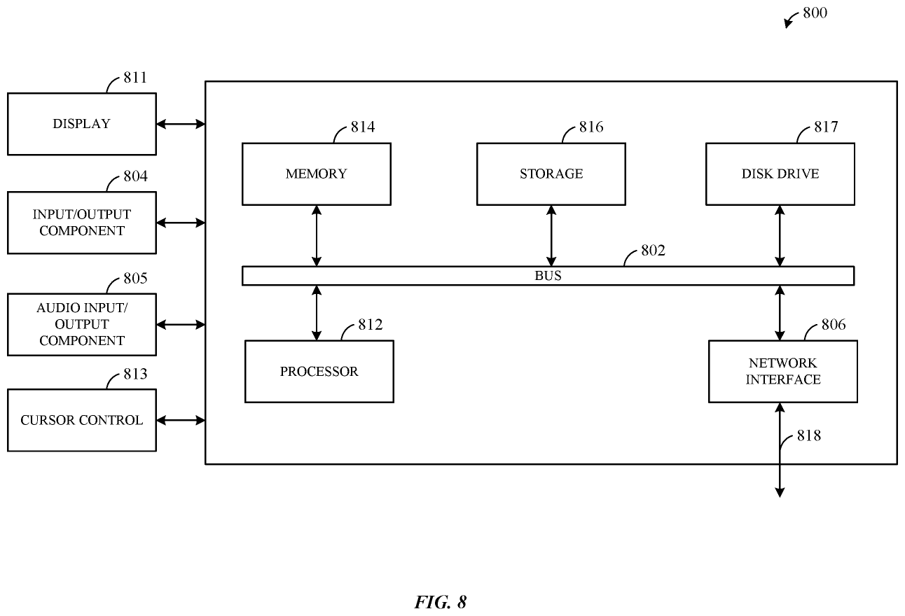

FIG. 5 is a flowchart of an example process 500 of performing a transaction periodicity forecast, according to an implementation of the present disclosure. One or more of the steps 502-508 of process 500 may be implemented, at least in part, in the form of executable code stored on non-transitory, tangible, machine-readable media that when run by one or more processors may cause the one or more processors to perform one or more of the steps 502-508. Some examples of computing devices, such as a computing system 800 (discussed below with reference to FIG. 8) may include non-transitory, tangible, machine readable media that include executable code that when run by one or more processors (e.g., a processor 812) may cause the one or more processors to perform the steps of process 500. As illustrated, the process 500 includes a number of enumerated steps, but aspects of the process 500 may include additional steps before, after, and in between the enumerated steps. In some aspects, one or more of the enumerated steps may be omitted or performed in a different order.

The process 500 starts at step 502, where the system may receive, through an application programming interface from a remote server, a first transaction request to process a transaction in an interaction between the remote server and a user device. In some aspects, the system may determine, using an input filtering engine, whether the transaction corresponds to a first merchant category of first remote servers that invoke a number of recurrent transaction requests that is lesser than a first threshold. The system also may pass, using the input filtering engine, the transaction to the machine learning-trained classifier for classification when the transaction is determined not to correspond to the first merchant category. In some implementations, the system may determine, using the input filtering engine, that the transaction corresponds to the first merchant category. The system also may determine, using the input filtering engine, whether the transaction corresponds to a second merchant category of second remote servers with a transactional behavior indicating invocation of a number of recurrent transaction requests in a transactional history of a plurality of user accounts that exceeds a second threshold. The system also may pass, using the input filtering engine, the transaction to the machine learning-trained classifier for classification when the transaction is determined to correspond to the second merchant category.

Next, at step 504, the system may classify, using a machine learning-trained classifier, the transaction as a recurrent transaction based at least in part on one or more periodicities associated with the transaction. In some implementations, the system may extract, using a feature extraction engine, one or more features of the transaction into a feature representation vector. In classifying the transaction, the system also may determine, using the machine learning-trained classifier, whether the transaction is classified as a recurrent transaction based at least in part on an estimated hyperplane relative to one or more support vectors from the feature representation vector.

In classifying the transaction, the system may generate, using the machine learning-trained classifier, an autocorrelation feature matrix for the transaction, the autocorrelation feature matrix including a plurality of correlation metrics indicating different correlations between a plurality of periodicities and a plurality of lag metrics, in which each of the plurality of lag metrics indicates an offset between a time of the transaction and a predetermined time window corresponding to one of the plurality of periodicities for providing, at least in part, an overlap between a transactional history that includes the transaction and the predetermined time window. In generating the autocorrelation feature matrix, the system may correlate each of the plurality of periodicities against each of the plurality of lag metrics to determine a correlation metric of the plurality of correlation metrics, in which each of the plurality of correlation metrics indicates a level of correlation between a periodicity of the plurality of periodicities and a lag metric of the plurality of lag metrics.

In classifying the transaction, the system may generate, using the machine learning-trained classifier, an associated tag for the transaction to classify the transaction as the recurrent transaction, the associated tag indicating a likelihood of which of the plurality of periodicities and the plurality of lag metrics are associated with the transaction. In some aspects, the recurrent flag is generated for the transaction based on the associated tag. In generating the associated tag, the system may generate a normalized probability distribution that includes a different likelihood value of a plurality of likelihood values for each pairing of a periodicity of the plurality of periodicities and a lag metric of the plurality of lag metrics, in which the associated tag comprises of the normalized probability distribution.

In classifying the transaction, the system may generate, using a transaction evaluation engine, an adjusted time window relative to the predetermined time window based on a periodicity of the plurality of periodicities and a lag metric of the plurality of lag metrics. The system also may determine, using the transaction evaluation engine, that the time of the transaction is within the adjusted time window. The system also may generate, using the recurrent flag engine, the recurrent flag based on the determining that the time of the transaction is within the adjusted time window.

Subsequently, at step 506, the system may generate a recurrent flag for the transaction based on the classifying.

Next, at step 508, the system may communicate, through the application programming interface to an issuer host device, a second transaction request comprising the transaction and the recurrent flag for authenticating the transaction at the issuer host device.

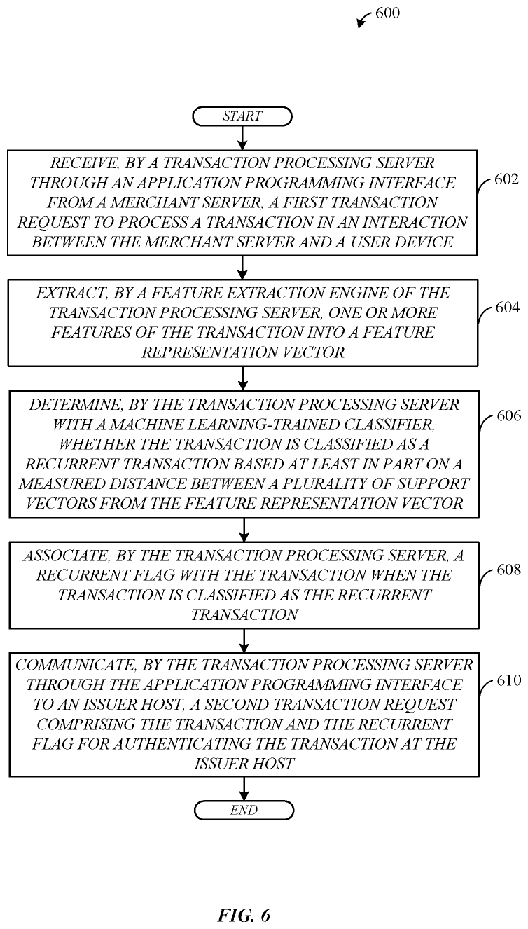

FIG. 6 is a flowchart of another example process of performing a transaction periodicity forecast, according to an implementation of the present disclosure. One or more of the steps 602-608 of process 600 may be implemented, at least in part, in the form of executable code stored on non-transitory, tangible, machine-readable media that when run by one or more processors may cause the one or more processors to perform one or more of the steps 602-608. Some examples of computing devices, such as computing system 800 may include non-transitory, tangible, machine readable media that include executable code that when run by one or more processors (e.g., processor 812) may cause the one or more processors to perform the steps of process 600. As illustrated, the process 600 includes a number of enumerated steps, but aspects of the process 600 may include additional steps before, after, and in between the enumerated steps. In some aspects, one or more of the enumerated steps may be omitted or performed in a different order.

The process 600 starts at step 602, where the system may receive, using a transaction processing server through an application programming interface from a remote server, a first transaction request to process a transaction in an interaction between the remote server and a user device. In receiving the first transaction request, the system may receive, from a database, a transactional history associated with the remote server for a predetermined time range, the transactional history comprising a plurality of transactions and a plurality of timestamps associated with respective ones of the plurality of transactions.

Next, at step 604, the system may extract, using a feature extraction engine, one or more features of the transaction into a feature representation vector. In extracting the one or more features of the transaction, the system may extract, using the feature extraction engine, the one or more features of each of the plurality of transactions, in which the one or more features includes features of a transaction cooperation document between the remote server and the user device that indicates whether the transaction occurs at a periodic frequency or a non-periodic frequency.

Subsequently, at step 606, the system may determine, using a machine learning-trained classifier, whether the transaction is classified as a recurrent transaction based at least in part on a measured distance between a plurality of support vectors from the feature representation vector. In determining whether the transaction is classified as the recurrent transaction, the system may determine, using the transaction processing server with the machine learning-trained classifier, whether the remote server invokes a number of recurrent transaction requests that exceeds a predetermined threshold based on the transactional history. The system also may add, using a merchant whitelist engine of the transaction processing server, the remote server to a whitelist indicating a number of remote servers that invoke recurrent transactions when the remote server is determined to invoke the number of recurrent transaction requests that exceeds the predetermined threshold.

Next, at step 608, the system may associate a recurrent flag with the transaction when the transaction is classified as the recurrent transaction. In generating the recurrent flag, the system may determine, using a recurrent flag engine, whether the remote server is included in a whitelist indicating a number of remote servers classified as invoking recurrent transactions. The system also may generate, by the recurrent flag engine, the recurrent flag when the remote server is included in the whitelist.

Subsequently, at step 610, the system may communicate, through the application programming interface to an issuer host device, a second transaction request comprising the transaction and the recurrent flag for authenticating the transaction at the issuer host device.

In some implementations, the process 600 may include steps for training, by at least one processor of the transaction processing server, the machine learning-trained classifier with a training dataset. In some aspects, the training dataset comprises different bias distributions indicating a first fraction of transactions that correspond to periodic transactions, a second fraction of transactions that correspond to non-periodic transactions, and a third fraction of transactions that correspond to a combination of periodic and non-periodic transactions. In other aspects, the different bias transactions are based, at least in part, on historical transaction data processed by the transaction processing server.

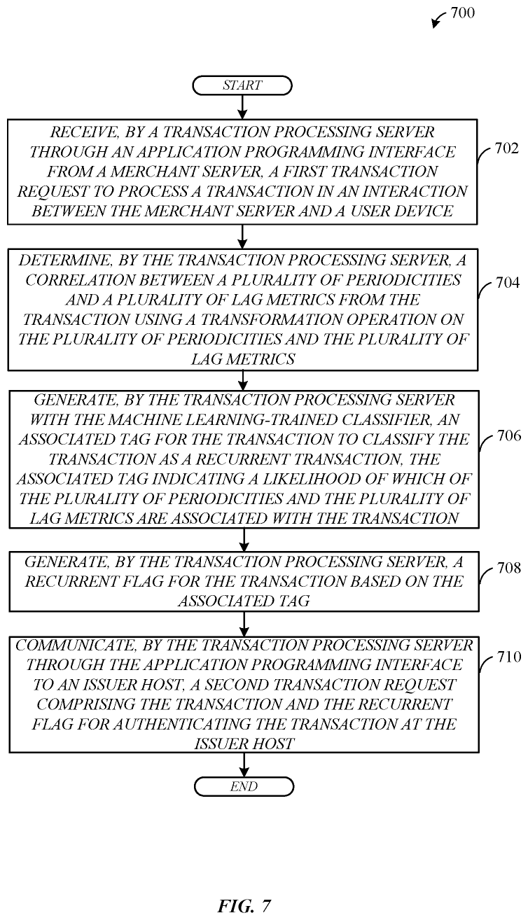

FIG. 7 is a flowchart of still another example process of performing a transaction periodicity forecast, according to an implementation of the present disclosure. One or more of the steps 702-708 of process 700 may be implemented, at least in part, in the form of executable code stored on non-transitory, tangible, machine-readable media that when run by one or more processors may cause the one or more processors to perform one or more of the steps 702-708. Some examples of computing devices, such as computing system 800 may include non-transitory, tangible, machine readable media that include executable code that when run by one or more processors (e.g., processor 812) may cause the one or more processors to perform the steps of process 700. As illustrated, the process 700 includes a number of enumerated steps, but aspects of the process 700 may include additional steps before, after, and in between the enumerated steps. In some aspects, one or more of the enumerated steps may be omitted or performed in a different order.

The process 700 starts at step 702, where the system may receive a first transaction request to process a transaction in an interaction between the remote server and a user device. In some implementations, the system may determine whether the transaction corresponds to a first merchant category of first remote servers that invoke a number of recurrent transaction requests that is lesser than a first threshold. The system also may pass the transaction for classification when the transaction is determined not to correspond to the first merchant category. In other aspects, the system may determine that the transaction corresponds to the first merchant category and determining whether the transaction corresponds to a second merchant category of second remote servers with a transactional behavior indicating invocation of a number of recurrent transaction requests in a transactional history of a plurality of user accounts that exceeds a second threshold. The system also may pass the transaction for classification when the transaction is determined to correspond to the second merchant category.

Next, at step 704, the system may determine a correlation between a plurality of periodicities and a plurality of lag metrics from the transaction using a transformation operation on the plurality of periodicities and the plurality of lag metrics. In determining the correlation, the system may generate an autocorrelation feature matrix for the transaction, the autocorrelation feature matrix including a plurality of correlation metrics indicating different correlations between the plurality of periodicities and the plurality of lag metrics, in which each of the plurality of lag metrics indicates an offset between a time of the transaction and a predetermined time window corresponding to one of the plurality of periodicities for providing, at least in part, an overlap between a transactional history that includes the transaction and the predetermined time window. In generating the autocorrelation feature matrix, the system may correlate each of the plurality of periodicities against each of the plurality of lag metrics to determine a correlation metric of the plurality of correlation metrics, in which each of the plurality of correlation metrics indicates a level of correlation between a periodicity of the plurality of periodicities and a lag metric of the plurality of lag metrics.

Subsequently, at step 706, the system may generate an associated tag for the transaction to classify the transaction as a recurrent transaction, the associated tag indicating a likelihood of which of the plurality of periodicities and the plurality of lag metrics are associated with the transaction. In generating the associated tag, the system may generate a normalized probability distribution that includes a different likelihood value of a plurality of likelihood values for each pairing of a periodicity of the plurality of periodicities and a lag metric of the plurality of lag metrics, in which the associated tag comprises of the normalized probability distribution.

Next, at step 708, the system may generate a recurrent flag for the transaction based on the associated tag. In some implementations, the system may generate an adjusted time window relative to the predetermined time window based on a periodicity of the plurality of periodicities and a lag metric of the plurality of lag metrics. The system also may determine that the time of the transaction is within the adjusted time window. In generating the recurrent flag, the system may generate the recurrent flag based on the determining that the time of the transaction is within the adjusted time window.

Subsequently, at step 710, the system may communicate a second transaction request comprising the transaction and the recurrent flag for authenticating the transaction at an issuer host device.

FIG. 8 is a block diagram of a computer system 800 suitable for implementing one or more components in FIG. 1, according to an implementation. In various implementations, a computing device may include a personal computing device e.g., smart phone, a computing tablet, a personal computer, laptop, a wearable computing device such as glasses or a watch, Bluetooth device, key FOB, badge, etc.) capable of communicating with the network. The service provider server 110 may utilize a network computing device (e.g., a network server) capable of communicating with the network 180. It should be appreciated that each of the devices utilized by users and service providers may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons, image, or links, and/or moving one or more images, etc., and sends a corresponding signal to bus 802. I/O component 804 may also include an output component, such as a display 811 and a cursor control 813 (such as a keyboard, keypad, mouse, etc.). An optional audio input/output component 805 may also be included to allow a user to use voice for inputting information by converting audio signals. Audio I/O component 805 may allow the user to hear audio. A transceiver or network interface 806 transmits and receives signals between computer system 800 and other devices, such as another communication device, service device, or a service provider server via network 180. In one implementation, the transmission is wireless, although other transmission mediums and methods may also be suitable. One or more processors 812, which can be a micro-controller, digital signal processor (DSP), or other processing component, processes these various signals, such as for display on computer system 800 or transmission to other devices via a communication link 818. Processor(s) 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor(s) 812 and other components by executing one or more sequences of instructions contained in system memory component 814. Logic may be encoded in a computer readable medium, which may refer to any medium that participates in providing instructions to processor(s) 812 for execution. Such a medium may take many forms, including but not limited to, non-volatile media, volatile media, and transmission media. In various implementations, non-volatile media includes optical or magnetic disks, volatile media includes dynamic memory, such as system memory component 814, and transmission media includes coaxial cables, copper wire, and fiber optics, including wires that include bus 802. In one implementation, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various implementations of the present disclosure, execution of instruction sequences to practice the present disclosure may be performed by computer system 800. In various other implementations of the present disclosure, a plurality of computer systems 800 coupled by communication link 818 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various implementations provided by the present disclosure may be implemented using hardware, software, or combinations of hardware and software. Also, where applicable, the various hardware components and/or software components set forth herein may be combined into composite components that include software, hardware, and/or both without departing from the spirit of the present disclosure. Where applicable, the various hardware components and/or software components set forth herein may be separated into sub-components that include software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems that include one or more memories storing various information described herein and one or more processors coupled to the one or more memories and a network, in which the one or more processors are operable to perform steps as described herein, as non-transitory machine-readable medium that includes a plurality of machine-readable instructions which, when executed by one or more processors, are adapted to cause the one or more processors to perform a method that includes steps described herein, and methods performed by one or more devices, such as a hardware processor, user device, server, and other devices described herein.

The foregoing disclosure is not intended to limit the present disclosure to the precise forms or particular fields of use disclosed. As such, it is contemplated that various alternate implementations and/or modifications to the present disclosure, whether explicitly described or implied herein, are possible in light of the disclosure. Having thus described implementations of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled to the non-transitory memory and configured to execute instructions from the non-transitory memory to cause the system to perform operations comprising:
receiving, through an application programming interface from a remote server, a first transaction request to process a transaction in an interaction between the remote server and a user device;
classifying, using a machine learning-trained classifier, the transaction as a recurrent transaction based at least in part on one or more periodicities associated with the transaction;
generating a recurrent flag for the transaction based on the classifying; and
communicating, through the application programming interface to an issuer host device, a second transaction request comprising the transaction and the recurrent flag for authenticating the transaction at the issuer host device.

2. The system of claim 1, wherein the classifying the transaction comprises:
generating, using the machine learning-trained classifier, an autocorrelation feature matrix for the transaction, the autocorrelation feature matrix including a plurality of correlation metrics indicating different correlations between a plurality of periodicities and a plurality of lag metrics, wherein each of the plurality of lag metrics indicates an offset between a time of the transaction and a predetermined time window corresponding to one of the plurality of periodicities for providing, at least in part, an overlap between a transactional history that includes the transaction and the predetermined time window.

3. The system of claim 2, wherein generating the autocorrelation feature matrix comprises:
correlating each of the plurality of periodicities against each of the plurality of lag metrics to determine a correlation metric of the plurality of correlation metrics, wherein each of the plurality of correlation metrics indicates a level of correlation between a periodicity of the plurality of periodicities and a lag metric of the plurality of lag metrics.

4. The system of claim 2, wherein the classifying the transaction comprises:
generating, using the machine learning-trained classifier, an associated tag for the transaction to classify the transaction as the recurrent transaction, the associated tag indicating a likelihood of which of the plurality of periodicities and the plurality of lag metrics are associated with the transaction,
wherein the recurrent flag is generated for the transaction based on the associated tag.

5. The system of claim 4, wherein the generating the associated tag comprises:
generating a normalized probability distribution that includes a different likelihood value of a plurality of likelihood values for each pairing of a periodicity of the plurality of periodicities and a lag metric of the plurality of lag metrics, wherein the associated tag comprises of the normalized probability distribution.

6. The system of claim 2, wherein the classifying the transaction comprises:
generating, using a transaction evaluation engine, an adjusted time window relative to the predetermined time window based on a periodicity of the plurality of periodicities and a lag metric of the plurality of lag metrics;
determining, using the transaction evaluation engine, that the time of the transaction is within the adjusted time window; and
generating, using a recurrent flag engine, the recurrent flag based on the determining that the time of the transaction is within the adjusted time window.

7. The system of claim 1, wherein the operations further comprise:
determining, using an input filtering engine, whether the transaction corresponds to a first merchant category of first remote servers that invoke a number of recurrent transaction requests that is lesser than a first threshold; and
passing, using the input filtering engine, the transaction to the machine learning-trained classifier for classification when the transaction is determined not to correspond to the first merchant category.

8. The system of claim 7, wherein the operations further comprise:
determining, using the input filtering engine, that the transaction corresponds to the first merchant category;
determining, using the input filtering engine, whether the transaction corresponds to a second merchant category of second remote servers with a transactional behavior indicating invocation of a number of recurrent transaction requests in a transactional history of a plurality of user accounts that exceeds a second threshold; and
passing, using the input filtering engine, the transaction to the machine learning-trained classifier for classification when the transaction is determined to correspond to the second merchant category.

9. The system of claim 1, wherein:
the operations further comprise:
extracting, using a feature extraction engine, one or more features of the transaction into a feature representation vector,
the classifying the transaction comprises:
determining, using the machine learning-trained classifier, whether the transaction is classified as a recurrent transaction based at least in part on an estimated hyperplane relative to one or more support vectors from the feature representation vector.

10. A method, comprising:
receiving, by a transaction processing server through an application programming interface from a remote server, a first transaction request to process a transaction in an interaction between the remote server and a user device;
extracting, by a feature extraction engine of the transaction processing server, one or more features of the transaction into a feature representation vector;
determining, by the transaction processing server with a machine learning-trained classifier, whether the transaction is classified as a recurrent transaction based at least in part on a measured distance between a plurality of support vectors from the feature representation vector;
associating, by the transaction processing server, a recurrent flag with the transaction when the transaction is classified as the recurrent transaction; and
communicating, by the transaction processing server through the application programming interface to an issuer host device, a second transaction request comprising the transaction and the recurrent flag for authenticating the transaction at the issuer host device.

11. The method of claim 10, wherein the receiving the first transaction request comprises:
receiving, by the transaction processing server from a database, a transactional history associated with the remote server for a predetermined time range, the transactional history comprising a plurality of transactions and a plurality of timestamps associated with respective ones of the plurality of transactions.

12. The method of claim 11, wherein the extracting the one or more features of the transaction comprises:
extracting, by the feature extraction engine, the one or more features of each of the plurality of transactions, wherein the one or more features includes features of a transaction cooperation document between the remote server and the user device that indicates whether the transaction occurs at a periodic frequency or a non-periodic frequency.

13. The method of claim 11, further comprising:
determining, by the transaction processing server using a merchant whitelist engine, whether the remote server invokes a number of recurrent transaction requests that exceeds a predetermined threshold based on the transactional history; and
adding, by the merchant whitelist engine of the transaction processing server, the remote server to a whitelist indicating a number of remote servers that invoke recurrent transactions when the remote server is determined to invoke the number of recurrent transaction requests that exceeds the predetermined threshold.

14. The method of claim 10, further comprising:
generating the recurrent flag comprising:
determining, by a recurrent flag engine of the transaction processing server, whether the remote server is included in a whitelist indicating a number of remote servers classified as invoking recurrent transactions; and
generating, by the recurrent flag engine, the recurrent flag when the remote server is included in the whitelist.

15. The method of claim 10, further comprising:
training, by at least one processor of the transaction processing server, the machine learning-trained classifier with a training dataset,
wherein the training dataset comprises different bias distributions indicating a first fraction of transactions that correspond to periodic transactions, a second fraction of transactions that correspond to non-periodic transactions, and a third fraction of transactions that correspond to a combination of periodic and non-periodic transactions, and
wherein the different bias transactions are based, at least in part, on historical transaction data processed by the transaction processing server.

16. A non-transitory machine-readable medium having stored thereon machine-readable instructions executable to cause a machine to perform operations comprising:
receiving a first transaction request to process a transaction in an interaction between the remote server and a user device;
determining a correlation between a plurality of periodicities and a plurality of lag metrics from the transaction using a transformation operation on the plurality of periodicities and the plurality of lag metrics;
generating an associated tag for the transaction to classify the transaction as a recurrent transaction, the associated tag indicating a likelihood of which of the plurality of periodicities and the plurality of lag metrics are associated with the transaction;
generating a recurrent flag for the transaction based on the associated tag; and
communicating a second transaction request comprising the transaction and the recurrent flag for authenticating the transaction at an issuer host device.

17. The non-transitory machine-readable medium of claim 16, wherein the determining the correlation comprises:
generating an autocorrelation feature matrix for the transaction, the autocorrelation feature matrix including a plurality of correlation metrics indicating different correlations between the plurality of periodicities and the plurality of lag metrics, wherein each of the plurality of lag metrics indicates an offset between a time of the transaction and a predetermined time window corresponding to one of the plurality of periodicities for providing, at least in part, an overlap between a transactional history that includes the transaction and the predetermined time window.

18. The non-transitory machine-readable medium of claim 17, wherein the generating the autocorrelation feature matrix comprises:
correlating each of the plurality of periodicities against each of the plurality of lag metrics to determine a correlation metric of the plurality of correlation metrics, wherein each of the plurality of correlation metrics indicates a level of correlation between a periodicity of the plurality of periodicities and a lag metric of the plurality of lag metrics.

19. The non-transitory machine-readable medium of claim 17, wherein the operations further comprise:
generating an adjusted time window relative to the predetermined time window based on a periodicity of the plurality of periodicities and a lag metric of the plurality of lag metrics; and
determining that the time of the transaction is within the adjusted time window,
wherein the generating the recurrent flag comprises:
generating the recurrent flag based on the determining that the time of the transaction is within the adjusted time window.

20. The non-transitory machine-readable medium of claim 16, wherein the generating the associated tag comprises:
generating a normalized probability distribution that includes a different likelihood value of a plurality of likelihood values for each pairing of a periodicity of the plurality of periodicities and a lag metric of the plurality of lag metrics, wherein the associated tag comprises of the normalized probability distribution.

21. The non-transitory machine-readable medium of claim 16, further comprising:
determining whether the transaction corresponds to a first merchant category of first remote servers that invoke a number of recurrent transaction requests that is lesser than a first threshold; and
passing the transaction for classification when the transaction is determined not to correspond to the first merchant category.

22. The non-transitory machine-readable medium of claim 21, further comprising:
determining that the transaction corresponds to the first merchant category;
determining whether the transaction corresponds to a second merchant category of second remote servers with a transactional behavior indicating invocation of a number of recurrent transaction requests in a transactional history of a plurality of user accounts that exceeds a second threshold; and
passing the transaction for classification when the transaction is determined to correspond to the second merchant category.
